(19) United States
(12) Patent Application Publication
(10) Pub. No.: US 2026/0255055 A1
(43) Pub. Date: Aug. 27, 2026

(54) SYSTEM, INFORMATION PROCESSING METHOD, AND NON-TRANSITORY RECORDING MEDIUM

(71) Applicant: Yuki NAGAHARA, Kanagawa (JP)

(72) Inventor: Yuki NAGAHARA, Kanagawa (JP)

(21) Appl. No.: 19/533,356

(22) Filed: Feb. 9, 2026

(30) Foreign Application Priority Data
Feb. 26, 2025 (JP) 2025-028744
Nov. 28, 2025 (JP) 2025-209243

(51) Int. Cl. H04N 23/661; H04N 7/14; H04N 23/698

(52) U.S. Cl. CPC H04N 23/661; H04N 7/147; H04N 23/698

(57) ABSTRACT

A system includes circuitry to distribute distribution image data to a plurality of communication terminals each located at a respective one of a plurality of sites, the distribution image data including a plurality of images captured at the plurality of sites; receive viewing-state information indicating a viewing state from each of the plurality of communication terminals in response to an operation by each of the plurality of communication terminals on a respective one of the plurality of images; store the received viewing-state information in a memory in association with the distribution image data; receive a reproduction request for reproducing the distribution image data from a communication terminal among the plurality of communication terminals after the distribution image data is distributed; and cause the communication terminal from which the reproduction request is received to display a viewing result, the viewing result being based on the viewing-state information.

### CROSS-REFERENCE TO RELATED APPLICATIONS

This patent application is based on and claims priority pursuant to 35 U.S.C. § 119(a) to Japanese Patent Application Nos. 2025-028744, filed on Feb. 26, 2025, and 2025-209243, filed on Nov. 28, 2025, in the Japan Patent Office, the entire disclosure of which is hereby incorporated by reference herein.

### BACKGROUND

### Technical Field

The present disclosure relates to a system, an information processing method, and a non-transitory recording medium.

### Related Art

A system of the related art generates image data, based on captured image data transmitted from an image capturing apparatus and time-series information of a predetermined area of the captured image data, by reflecting viewing states of respective users in the captured image data, and distributes the image data to communication terminals of the respective users. In the system, when a user reviews the distributed image data later, for example, a region focused on by the user in image data can be identified by the user.

### SUMMARY

The present disclosure described herein provides a system including circuitry. The circuitry distributes distribution image data to a plurality of communication terminals each located at a respective one of a plurality of sites. The distribution image data includes a plurality of images captured at the plurality of sites. The circuitry receives viewing-state information indicating a viewing state from each of the plurality of communication terminals in response to an operation by each of the plurality of communication terminals on a respective one of the plurality of images. The circuitry stores the received viewing-state information in a memory in association with the distribution image data. The circuitry receives a reproduction request for reproducing the distribution image data from a communication terminal among the plurality of communication terminals after the distribution image data is distributed. The circuitry causes the communication terminal from which the reproduction request is received to display a viewing result, the viewing result being based on the viewing-state information.

The present disclosure described herein provides an information processing method including distributing distribution image data to a plurality of communication terminals each located at a respective one of a plurality of sites, the distribution image data including a plurality of images captured at the plurality of sites; receiving viewing-state information indicating a viewing state from each of the plurality of communication terminals in response to an operation by each of the plurality of communication terminals on a respective one of the plurality of images; storing the received viewing-state information in a memory in association with the distribution image data; receiving a reproduction request for reproducing the distribution image data from a communication terminal among the plurality of communication terminals after the distribution image data is distributed; and causing the communication terminal from which the reproduction request is received to display a viewing result, the viewing result being based on the viewing-state information.

The present disclosure described herein provides a non-transitory recording medium storing a plurality of instructions which, when executed by one or more processors, causes the one or more processors to perform the above-described information processing method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of remote communication using a wide-view image;

FIG. 2 is a diagram illustrating an example schematic configuration of a communication system;

FIG. 3 is a diagram illustrating an example hardware configuration of an image capturing apparatus;

FIG. 4 is a diagram illustrating an example hardware configuration of a communication terminal and an information processing system;

FIGS. 5A, 5B, and 5C are a left side view, a front view, and a plan view of the image capturing apparatus according to an embodiment of the present disclosure, respectively;

FIG. 6 is an illustration of an example of how the image capturing apparatus is used;

FIGS. 7A, 7B, and 7C are diagrams illustrating an example of a hemispherical image (front side) captured by the image capturing apparatus, an example of a hemispherical image (back side) captured by the image capturing apparatus, and an example of an image in equirectangular projection, respectively;

FIG. 8A is an illustration of an example of how the image in equirectangular projection is mapped to a surface of a sphere;

FIG. 8B is a diagram illustrating an example of a spherical image;

FIG. 9 is a diagram illustrating an example of the positions of a virtual camera and a predetermined area in a case where the spherical image is of a three-dimensional sphere;

FIG. 10A is a perspective view of an example of the virtual camera and the predetermined area illustrated in FIG. 9;

FIG. 10B is a diagram illustrating an example of an image of the predetermined area displayed on a display;

FIG. 11 is a diagram illustrating an example of the relationship between predetermined-area information and the image of the predetermined area;

FIG. 12 is a diagram illustrating an example of a point in a three-dimensional Euclidean space defined in spherical coordinates;

FIG. 13 is a diagram illustrating an example functional configuration of the communication system;

FIGS. 14A and 14B are illustrations of examples of image management information stored in an image management information storage unit;

FIG. 15 is an illustration of an example of virtual room information stored in a virtual room information storage unit;

FIG. 16 is a sequence diagram illustrating an example of a process in which a user (or the communication terminal) enters a virtual room;

FIG. 17 is a diagram illustrating an example of a virtual room association screen for associating the image capturing apparatus with a virtual room;

FIG. 18 is a diagram illustrating an example of a virtual room association screen;

FIG. 19 is a diagram illustrating an example of a virtual room association screen;

FIGS. 20A and 20B are diagrams illustrating examples of a wide-view image transmission start/stop dialog displayed on the communication terminal;

FIG. 21 is a sequence diagram illustrating an example of a procedure in which a user registers the image capturing apparatus in a virtual room;

FIG. 22 is a sequence diagram illustrating an example of a process for sharing a wide-view image;

FIGS. 23A and 23B are diagrams illustrating an example of a viewing-state storage unit;

FIGS. 24A and 24B are diagrams illustrating an example of an aggregate-result storage unit;

FIG. 25 is a sequence diagram illustrating an example of an operation of the communication system;

FIG. 26 is a first diagram illustrating an example of a screen displayed on the communication terminal;

FIG. 27 is a second diagram illustrating an example of a screen displayed on the communication terminal;

FIG. 28 is a third diagram illustrating an example of a screen displayed on the communication terminal;

FIG. 29 is a fourth diagram illustrating an example of a screen displayed on the communication terminal;

FIG. 30 is another sequence diagram illustrating an example of an operation of the communication system;

FIG. 31 is a diagram illustrating an example of remote communication using the communication system in telemedicine; and

FIG. 32 is a diagram illustrating an example of a virtual room association screen for associating the image capturing apparatus with a virtual room for telemedicine.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an image sharing method performed by the information processing system will be described hereinafter as an example of an embodiment of the present disclosure.

### Example of Remote Communication

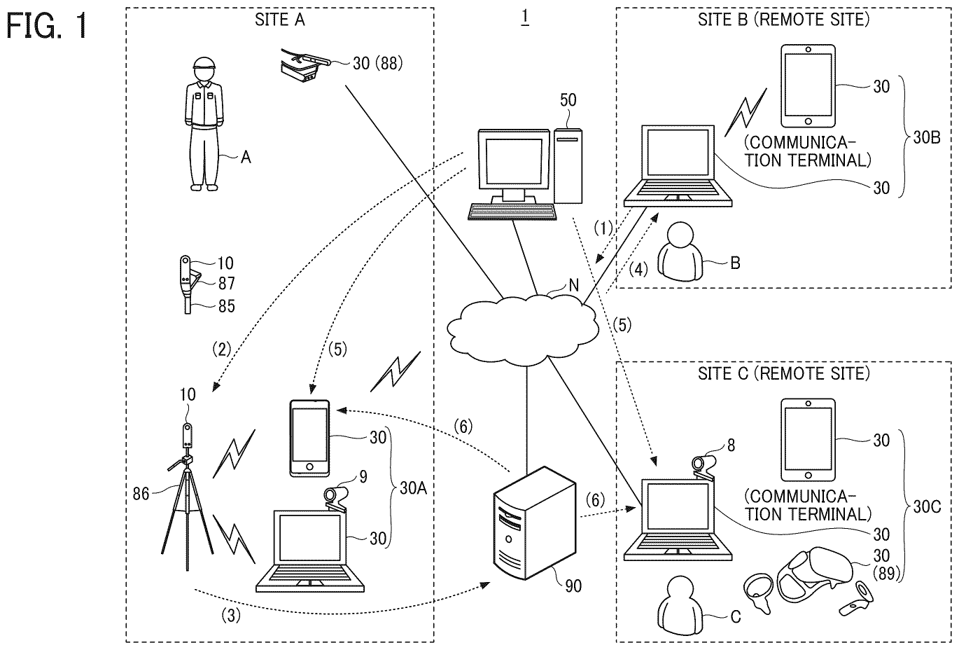

FIG. 1 is a diagram illustrating an example of a communication system 1 for implementing remote communication using a wide-view image. In the communication system 1 illustrated in FIG. 1, communication takes place across three sites, namely, a site A, a site B, and a site C, via an information processing system 50. Three sites are merely an example, and communication may be performed across two sites or four or more sites. Remote communication refers to communication that takes place between individuals at physically distant locations by using information technology (IT) tools through images and/or audio.

The sites A, B, and C are any sites across which a wide-view image can be communicated. In one example, the sites A, B, and C are offices. An image capturing apparatus 10 is placed at the site A. In one example, the image capturing apparatus 10 captures a wide-angle image called a spherical image and an image with a wide angle of view ranging from, for example, 180 degrees to 360 degrees in the horizontal direction. Such an image with a wide angle of view is hereinafter simply referred to as a “wide-view image”. Communication terminals 30A, 30B, and 30C for viewing a wide-view image are placed at the sites A, B, and C, respectively. Any communication terminal or communication terminals among the communication terminals 30A to 30C are hereinafter referred to as a “communication terminal 30” or “communication terminals 30”.

In the present embodiment, the entire site A is captured in a wide-view image and, for a region that is to be focused on, a user at each of the sites A, B, and C can change a point of view as desired to view the wide-view image. The term “point of view” refers to the center position or range of the entire wide-view image. The center position or range of the entire wide-view image is to be displayed on displays or other means of the communication terminals 30A to 30C.

In one example, the image capturing apparatus 10 is attached to a tripod 86. In another example, the image capturing apparatus 10 is attached to an arm 85 through a gimbal 87. A relay device is installed at the site A. In FIG. 1, the communication terminal 30A also functions as the relay device. The communication terminal 30A receives a wide-view image from the image capturing apparatus 10 via a wire or wirelessly and transmits the received wide-view image to the information processing system 50. The communication terminal 30A may also function as a terminal for viewing the wide-view image. In one example, an image capturing apparatus 9 connected to (or incorporated in) the communication terminal 30A captures an image having a normal angle of view (or a spherical image), and the captured image is transmitted to the information processing system 50. In another example, smart glasses 88 worn by a user A capture an image having a normal angle of view (or a spherical image), and the captured image is transmitted to the information processing system 50. The user A may be a worker. The smart glasses 88 are an information terminal having a display on which information acquired via the Internet is displayed with a field of view maintained. The smart glasses 88 may be placed at any site.

As examples of the communication terminal 30B, a personal computer (PC) and a smartphone are placed at the site B. The communication terminal 30B is any device communicable with the information processing system 50 via a communication network N. Other examples of the communication terminal 30B include display devices such as a tablet terminal, a personal digital assistant (PDA), an electronic whiteboard, and a projector. A camera may be incorporated in or connected to the communication terminal 30B.

As examples of the communication terminal 30C, a PC, a smartphone, and virtual reality (VR) goggles 89 are placed at the site C. In FIG. 1, an image capturing apparatus 8 is incorporated in or connected to the communication terminal 30C. The VR goggles 89 are an information terminal for displaying a computer-based artificial world or a spherical image in accordance with the direction of movement of the neck or the body of the user wearing the VR goggles 89. The image capturing apparatus 8 may be for a wide angle of view or a normal angle of view. The communication terminal 30C is any device communicable with the information processing system 50 via the communication network N. Other examples of the communication terminal 30C include display devices such as a tablet terminal, a PDA, an electronic whiteboard, and a projector. The VR goggles 89 may be placed at any site.

In the present embodiment, the image capturing apparatus 10 and the communication terminals 30 are managed using a communication group referred to as a virtual room. The image capturing apparatus 10 is associated with the virtual room. Each of the communication terminals 30 (the user who operates each of the communication terminals 30) enters the virtual room to receive a wide-view image transmitted from the image capturing apparatus 10. As a result, the user can view the wide-view image. The smart glasses 88 and the VR goggles 89 may also be associated with the virtual room. The image capturing apparatuses 8 and 9 enter the virtual room together with the communication terminals 30.

The user A at the site A, a user B at the site B, and a user C at the site C are each allowed to change the point of view for the wide-view image, as desired. Thus, the users A to C may view the wide-view image in real time from different points of view. It may be difficult for the users A to C to mutually understand each other. In the present embodiment, accordingly, point-of-view information indicating a point of view of a user of the communication terminal 30 at any site is shared by users of the communication terminals 30 at the other sites. In other words, for example, point-of-view information indicating a point of view of a user of the communication terminal 30 at the site A is used as point-of-view information of users of the communication terminals 30 at the other sites, namely, the sites B and C. An overview of the sharing of point-of-view information will be described. In the following description, in one example, point-of-view information indicating a point of view of the user B at the site B is shared by the user A at the site A and the user C at the site C.
(1) The communication terminals 30A to 30C share a wide-view image (an example of a first wide-view image) captured by the image capturing apparatus 10. In response to the user B making a request to capture a wide-view image while viewing the wide-view image from any point of view on the communication terminal 30B, the communication terminal 30B (an example of a first communication terminal) transmits point-of-view information and the request to the information processing system 50.
(2) In response to the request, the information processing system 50 designates point-of-view information and transmits an image capturing request to the image capturing apparatus 10 to capture an image (either a still image or a moving image).
(3) The image capturing apparatus 10 captures a wide-view image (an example of a second wide-view image) in response to the image capturing request, and stores the wide-view image and the point-of-view information in a location specified by a uniform resource locator (URL) transmitted from the information processing system 50. The URL is an example of storage location information. In FIG. 1, the image capturing apparatus 10 stores the wide-view image and the point-of-view information in storage 90. The wide-view image stored in the storage 90 may be downloaded and displayed on any communication terminal 30.
(4) The information processing system 50 transmits the URL to the communication terminal 30B.
(5) The information processing system 50 further transmits the URL to the communication terminals 30A and 30C (examples of second communication terminals), which are in the same virtual room as that which the image capturing apparatus 10 and the communication terminal 30B are in, automatically or in response to a request from the user B.
(6) The communication terminals 30A and 30C connect to the URL and receive the point-of-view information and the wide-view image. Each of the communication terminals 30A and 30C sets and displays a point of view identified by the point-of-view information for the wide-view image such that the point of view matches the center of an image area. In one example, the point of view is not made to completely match the center of the image area. In another example, the point of view may be set and displayed so as to be included in a range near the center of the image area.

The same applies when the point of view of the user A at the site A is shared by the users B and C at the sites B and C and when the point of view of the user C at the site Cis shared by the users A and B at the sites A and B.

As described above, in the communication system 1, even in a case where a wide-view image is distributed, point-of-view information is shared across the respective sites. This facilitates understanding among users at the respective sites.

In (3), the image capturing apparatus 10 may transmit the wide-view image itself to the information processing system 50. In (4), the information processing system 50 may transmit the wide-view image to the communication terminals 30A to 30C.

The communication system 1 illustrated in FIG. 1 is also applicable to VR education, event distribution, remote customer services, telemedicine services, and other situations in the present embodiment. In VR education, the image capturing apparatus 10 is placed at a site such as a study room or a laboratory. Students can view a blackboard, an instrument, a sample, or an experimental result from remote sites while changing the points of view as appropriate. In event distribution, the image capturing apparatus 10 is placed in a venue of an event to be held on-site. Event participants such as an audience can view the details in the venue online from remote sites while changing the points of view as appropriate. The details in the venue include images of event performers, event participants, and event presenters, images of objects involved in the event, such as products and exhibits, images of materials involved in the event, and images of the venue. The event may be held indoors or outdoors, and examples of the venue of the event include venues such as sports stadiums, concert halls, and theaters. In remote customer services, for example, in customer services for a travel agency, the image capturing apparatus 10 is placed at each of travel destination sites. A customer can plan their itinerary from a remote site while changing the point of view as appropriate.

Images may be captured at any sites other than those described above. An image may be captured in any space that a user (or viewer) at a viewing site desires to remotely grasp. Examples of such a space include a school, a factory, a warehouse, a building site, a server room, and a store.

### Terminology

The term “tenant” refers to an entity such as a company or an organization that has a contract with a service provider to receive an image distribution service. In the present embodiment, the service provider is the information processing system 50. In one example, a user belongs to a tenant. In another example, a user may personally subscribe to a service. A user, an image capturing apparatus, or a virtual room are registered in a tenant.

The term “site” refers to a location where activity takes place. In the present embodiment, a conference room is used as an example of a site. The conference room is a room used for a conference. A conference is also referred to as a meeting, a session, a gathering, an assembly, a get-together, or a briefing.

The term “site” is also used to include a location at which an image capturing apparatus for distributing captured moving images or still images is installed but a user who performs activities is absent.

The term “device” refers to a piece of equipment that is not a general-purpose communication terminal 30 such as a PC or a smartphone. In one example, the device is an image capturing apparatus or an apparatus for viewing a wide-view image. In the present embodiment, examples of the device include the image capturing apparatus 10, the smart glasses 88, and the VR goggles 89.

The term “point-of-view information” refers to parameter information that specifies which predetermined area in a wide-view image to be displayed on a display is to be displayed on the display. In the present embodiment, in one example, a radius vector, a polar angle, and an azimuth angle of the center of the wide-view image to be displayed on the display are described as examples of the point-of-view information. In another example, the point-of-view information may be specified by other parameter information such as the coordinates of diagonal vertices.

The term “wide-view image” refers to an image having a wide viewing angle and captured in a wide imaging range. The term “wide-view image” is used to include a 360-degree image that is a captured image of an entire 360-degree view. The 360-degree image is also referred to as a spherical image, an omnidirectional image, or an “all-around” image. The wide-view image has a display range corresponding to a field of view of up to 360 degrees in the vertical direction and a field of view of up to 360 degrees in the horizontal direction. In an example, the wide-view image is an image having a display range corresponding to a field of view of less than 360 degrees in the vertical and horizontal directions as long as the wide-view image has a viewing angle in a wider range than the display range that can be displayed on the display at a time. The wide-view image also includes an image having a display range wider than a range that can be visually recognized at a time by a person looking at the range. Depending on the display method, an image that can be displayed on the display at a time is also included in the wide-view image as long as the image has a wide range of viewing angles in a predetermined display method. In the present embodiment, a spherical image in equirectangular projection format is used as an example of a wide-view image. Other examples of the wide-view image include an omnidirectional image, a hemispherical image, a three-dimensional (3D) panoramic image, a two-dimensional (2D) panoramic image, and a VR image.

An image having a normal angle of view is not a wide-view image. In the present embodiment, such an image is referred to as a non-wide-view image, that is, a planar image.

The term “communication group” refers to a group of users who share a wide-view image, that is, a group of users to whom a wide-view image is to be distributed. The communication group will be described using the term “virtual room” in the sense that in a typical space, the users in the same room can share a wide-view image. The term “virtual” refers to being implemented by information processing via a network.

The term “remote communication” refers to communication that takes place between individuals at physically distant locations by using IT tools through images and/or audio.

The term “VR education” refers to an educational tool that uses VR technology to encourage children to explore academic interests to deepen understanding. The VR technology creates a simulated world and immerses users in the world that the users are seeing as if the users were physically present in the world.

The term “remote customer service” refers to a customer service in which staff at a remote location provide product guidance to a user via a tablet or a display by using video conferencing.

The term “image” refers to a visual representation of an event that is fixed on a medium. The term “video” refers to an image displayed on a display device. Video is included in an image.

Users at respective sites perform remote communication across remote locations. The remote communication is a meeting, which is an online meeting, accessible from remote locations, or sites. The meeting refers to, for example, a gathering of people for consultation, or discussion. Examples of the meeting include, but are not limited to, serving a customer, a conference, an assembly, a briefing, a study session, a class, a seminar, and a presentation. The remote communication is not necessarily bidirectional communication. Thus, the virtual room may also be referred to as a virtual conference room.

### Example Configuration of Communication System

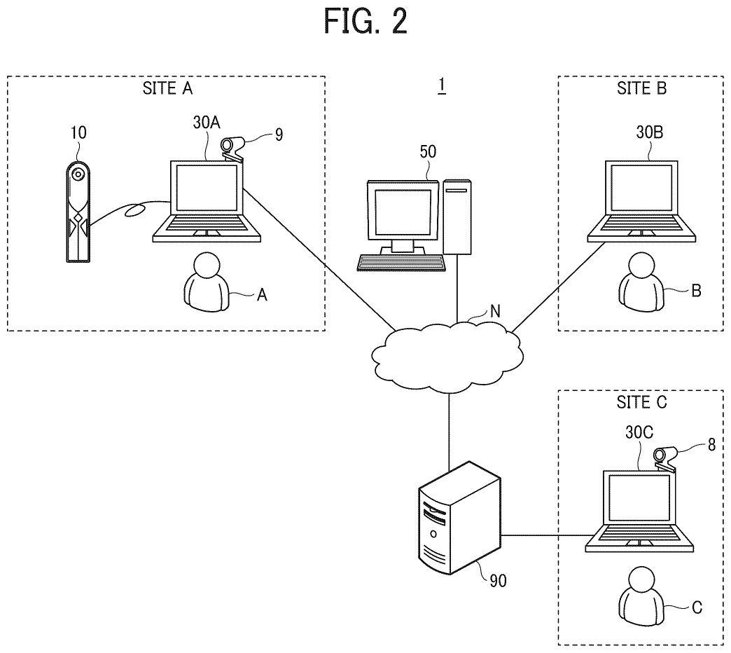

FIG. 2 is a diagram illustrating an example schematic configuration of the communication system 1. The communication system 1 is a system for transmitting and receiving a wide-view image captured by the image capturing apparatus 10 or an image having a normal angle of view bidirectionally across a plurality of sites. In the communication system 1, an image distributed from one of the sites is displayed at the other sites and is viewable to users at the other sites. In an example of the wide-view image, a spherical image captured by the image capturing apparatus 10 is distributed. In the communication system 1, for example, a wide-view image captured at a predetermined site is remotely viewable at another site.

In the communication system 1, as illustrated in FIG. 2, the image capturing apparatus 10 and the communication terminal 30A placed at the site A, the information processing system 50, and the communication terminals 30B and 30C placed at a plurality of sites, namely, the sites B and C, respectively, are communicably connected to each other.

In a case where the image capturing apparatus 10 is directly connectable to the communication network N, the communication terminal 30A, serving as a relay device (e.g., a router), does not use the relay function. In this case, the communication terminal 30A is connected to the communication network N irrespective of the image capturing apparatus 10. In a case where the communication terminal 30A is placed at the site A, the communication terminal 30A also functions as a relay device, and the user A can view a wide-view image in a manner similar to that of the communication terminals 30B and 30C. The image capturing apparatus 10 may additionally be placed at a site other than the site A, or a plurality of image capturing apparatuses 10 may be placed at the site A.

Each communication terminal 30 and the information processing system 50 can communicate with each other via the communication network N. The communication network N includes the Internet, a mobile communication network, and a local area network (LAN), for example. The communication network N may include a wired communication network and a wireless communication network. The wireless communication network may be based on a wireless communication standard such as third generation (3G), fourth generation (4G), fifth generation (5G), Wireless Fidelity (Wi-Fi®), Worldwide Interoperability for Microwave Access (WiMAX), or Long Term Evolution (LTE).

The image capturing apparatus 10 is a special digital camera configured to capture an image of an object and/or surroundings such as scenery to obtain two hemispherical images, from which a spherical image is generated, as described below. The wide-view image obtained by the image capturing apparatus 10 may be a moving image or a still image, or may include both a moving image and a still image. In the following description, information including captured image data and audio data acquired during capturing of a captured image indicated by the captured image data may be referred to as video.

The communication terminal 30 is a computer such as a PC operated by a user at each site. The communication terminal 30 displays an image captured at the site where the communication terminal 30 is placed, and a wide-view image (still image and/or moving image) and an image having a normal angle of view, which are distributed from other sites. For example, the communication terminal 30 acquires a wide-view image, which is captured by the image capturing apparatus 10, via the communication network N. The communication terminal 30 has installed therein software for executing image processing, such as Open Graphics Library for Embedded Systems (OpenGL ES), and can display an image based on point-of-view information that specifies a partial area in the wide-view image. OpenGL ES is an example of software for executing image processing. Any other software may be used. In an example, the communication terminal 30 does not have installed therein software for executing image processing, and executes image processing by using software received from the outside or receives a result of image processing executed by external software to display an image. That is, the communication terminal 30 can display a predetermined area, which is a portion of the wide-view image.

The communication terminal 30 can change the point of view for the display range of the wide-view image, as desired, in response to the user's operation. The communication terminal 30 shifts the virtual point of view in accordance with a user operation input (such as key input, dragging, or scrolling) on, for example, a touch panel, a direction button, a mouse, a keyboard, or a touch pad, to change and display a visual field range (predetermined area) based on point-of-view information corresponding to the shifted point of view. In an example, the communication terminal 30 is a communication terminal to be worn by the user, such as VR goggles. In response to a change in the movement of the user wearing the communication terminal 30, position information of the communication terminal 30 is changed. In response to detection of the change in the position information, the virtual point of view is shifted in accordance with the detected position information to change a visual field range (predetermined area), based on point-of-view information corresponding to the shifted point of view, and the changed visual field range (predetermined area) is displayed.

The communication terminal 30A acquires a wide-view image from the image capturing apparatus 10 via a wired cable such as a Universal Serial Bus (USB) cable and distributes the acquired wide-view image to the communication terminal 30 at another site via the information processing system 50. The connection between the image capturing apparatus 10 and the communication terminal 30A may be either a wired connection using a wired cable or a wireless connection using short-range wireless communication, for example. A plurality of communication terminals 30A may be placed at the site A.

In an example, the user A at the site A wears the smart glasses 88, and the smart glasses 88 are connected to the communication network N. In this case, an image captured by the smart glasses 88 may be transmitted to the information processing system 50 via the communication network N, and the information processing system 50 may distribute the image to the communication terminal 30 at each site.

The communication terminal 30B is placed at the site B where the user B is located, and the communication terminal 30C is placed at the site C where the user C is located. A plurality of communication terminals 30B may be placed at the site B, and a plurality of communication terminals 30C may be placed at the site C. The users B and C may carry the communication terminals 30B and 30C, respectively.

Each of the communication terminals 30A to 30C at the sites A to C may be internally or externally provided with the image capturing apparatus 8 or 9. Each of the communication terminals 30A to 30C may distribute an image of the respective one of the sites A to C, which is captured by the image capturing apparatus 8 or 9 thereof, to the other sites. Any device may be placed at each of the sites A to C.

The arrangement of the terminals and apparatuses (i.e., the communication terminals 30 and the image capturing apparatuses 8, 9, and 10) and the users A to C illustrated in FIG. 2 is an example. Any other arrangement may be used. Examples of the communication terminal 30 may include a PC, a tablet terminal, a smartphone, a wearable terminal, a projector, an interactive white board (IWB), and a telepresence robot. The IWB is an electronic whiteboard with mutual communication capability. The communication terminal 30 is any computer on which a web browser or an application dedicated to an image distribution service operates.

In an example, the image capturing apparatus 10 includes a display and displays an image distributed from another site on the display.

The information processing system 50 includes one or more information processing apparatuses. The information processing system 50 manages and controls communication among the image capturing apparatus 10 and the communication terminals 30 at the respective sites and manages a wide-view image to be transmitted and received. The information processing system 50 provides a platform on which a function of providing an image distribution service for distributing a wide-view image is available. The platform may be made available to a person, a company, or any other service provider that desires to provide an image distribution service, under contract. A service provider that provides an image distribution service to a user by using a platform is hereinafter referred to as a platform contractor to distinguish the service provider from a tenant that receives the image distribution service.

The information processing system 50 may publish an application programming interface (API) as a platform, and the platform contractor may use the API to provide various image distribution services. The platform contractor develops software such as an application for calling the API or the screen to be displayed on the communication terminal 30. That is, the functions to be provided by the API, such as image distribution, are not developed from scratch.

The information processing system 50 may be implemented by a single computer or a plurality of computers such that the components (functions or units) of the information processing system 50 are divided into and assigned to the plurality of computers as appropriate. All or some of the functions of the information processing system 50 may be implemented by a server computer residing in a cloud environment or a server computer residing in an on-premises environment.

The storage 90 is a storage device separate from the information processing system 50. In one example, the storage 90 is external storage. The external storage may be cloud or on-premises storage. In another example, the storage 90 is storage included in the information processing system 50.

### Example Hardware Configuration

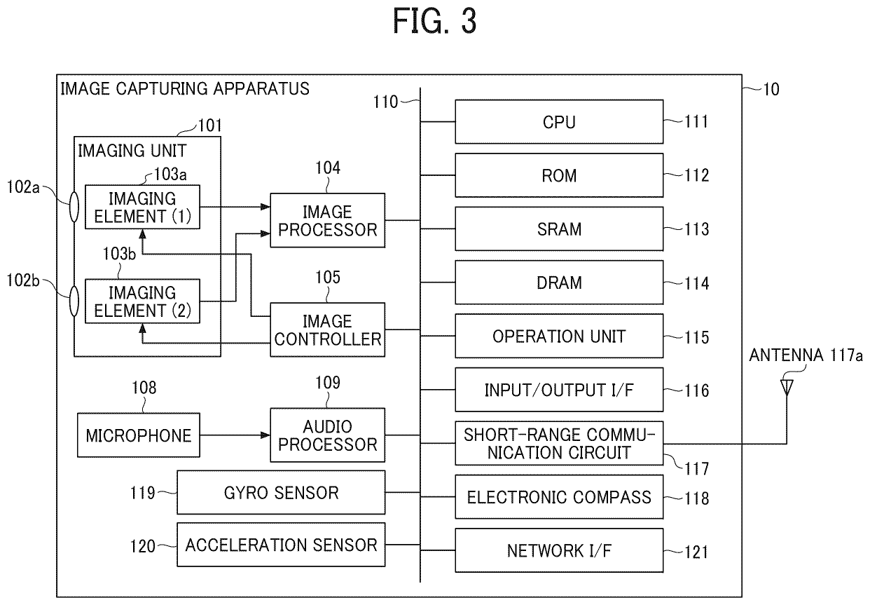

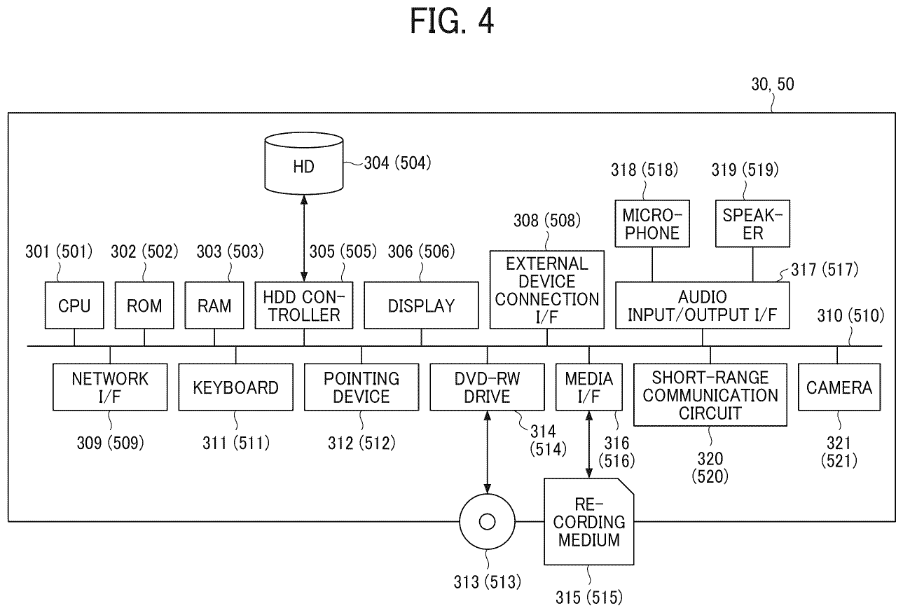

Next, the hardware configuration of each apparatus or terminal included in the communication system 1 according to the present embodiment will be described with reference to FIG. 3 or 4. In the hardware configurations illustrated in FIGS. 3 and 4, a certain hardware element may be added or deleted as appropriate.

### Hardware Configuration of Image Capturing Apparatus

First, the hardware configuration of the image capturing apparatus 10 will be described with reference to FIG. 3. FIG. 3 is a diagram illustrating an example hardware configuration of the image capturing apparatus 10. In the following description, the image capturing apparatus 10 is a spherical (omnidirectional) image capturing apparatus including two imaging elements. In some embodiments, the image capturing apparatus 10 includes any number of imaging elements, provided that the image capturing apparatus 10 includes at least two imaging elements. In one example, the image capturing apparatus 10 is not dedicated to omnidirectional image capturing, and an external omnidirectional image capturing unit is attached to a general-purpose digital camera, or a smartphone to implement functions that are substantially the same as those of the image capturing apparatus 10.

As illustrated in FIG. 3, the image capturing apparatus 10 includes an imaging unit 101, an image processor 104, an image controller 105, a microphone 108, an audio processor 109, a central processing unit (CPU) 111, a read only memory (ROM) 112, a static random access memory (SRAM) 113, a dynamic random access memory (DRAM) 114, an operation unit 115, an input/output interface (I/F) 116, a short-range communication circuit 117, an antenna 117a for the short-range communication circuit 117, an electronic compass 118, a gyro sensor 119, an acceleration sensor 120, and a network I/F 121.

The imaging unit 101 includes two wide-angle lenses (so-called fish-eye lenses) 102a and 102b (collectively referred to as a lens 102 unless distinguished), each having an angle of view of greater than or equal to 180 degrees so as to form a hemispherical image. The imaging unit 101 further includes two imaging elements 103a and 103b corresponding to the lenses 102a and 102b, respectively. Each of the imaging elements 103a and 103b includes an image sensor such as a complementary metal oxide semiconductor (CMOS) sensor or a charge-coupled device (CCD) sensor, a timing generation circuit, and a group of registers. The image sensor converts an optical image formed by the lens 102a or 102b into an electric signal and outputs image data. The timing generation circuit generates horizontal or vertical synchronization signals or pixel clocks for the image sensor. In the group of registers, various commands or parameters for an operation of the imaging element 103a or 103b are set. As a non-limiting example, the imaging unit 101 includes two wide-angle lenses. The imaging unit 101 may include one wide-angle lens or three or more wide-angle lenses.

Each of the imaging elements 103a and 103b of the imaging unit 101 is connected to the image processor 104 via a parallel I/F bus. Further, each of the imaging elements 103a and 103b of the imaging unit 101 is connected to the image controller 105 via a serial I/F bus such as an inter-integrated circuit (I2C) bus. The image processor 104, the image controller 105, and the audio processor 109 are connected to the CPU 111 via a bus 110. The ROM 112, the SRAM 113, the DRAM 114, the operation unit 115, the input/output I/F 116, the short-range communication circuit 117, the electronic compass 118, the gyro sensor 119, the acceleration sensor 120, and the network I/F 121 are also connected to the bus 110.

The image processor 104 acquires respective images output from the imaging elements 103a and 103b via the parallel I/F buses and performs predetermined processing on the image data. Thereafter, the image processor 104 combines the image data to generate data of an equirectangular projection image described below.

The image controller 105 usually functions as a master device while each of the imaging elements 103a and 103b usually functions as a slave device. The image controller 105 sets commands in the group of registers of each of the imaging elements 103a and 103b via the I2C bus. The image controller 105 receives various commands from the CPU 111. The image controller 105 further acquires status data of the group of registers of each of the imaging elements 103a and 103b via the I2C bus. The image controller 105 sends the acquired status data to the CPU 111.

The image controller 105 instructs the imaging elements 103a and 103b to output the image data at the time when a shutter button of the operation unit 115 is pressed. In an example, the image capturing apparatus 10 displays a preview image or a moving image (movie) on a display. Examples of the display include a display of a smartphone or any other external terminal that performs short-range communication with the image capturing apparatus 10 through the short-range communication circuit 117. In the case of displaying a movie, image data are continuously output from the imaging elements 103a and 103b at a predetermined frame rate (expressed in frames per minute).

As described below, the image controller 105 operates in cooperation with the CPU 111 to synchronize the time when the imaging element 103a outputs image data and the time when the imaging element 103b outputs image data. In the present embodiment, the image capturing apparatus 10 does not include a display unit (or display). In some embodiments, the image capturing apparatus 10 may include a display unit. The microphone 108 converts sound to audio (signal) data. The audio processor 109 acquires audio data output from the microphone 108 via an I/F bus and performs predetermined processing on the audio data.

The CPU 111 controls the overall operation of the image capturing apparatus 10 and performs predetermined processing. The ROM 112 stores various programs to be executed by the CPU 111. Each of the SRAM 113 and the DRAM 114 operates as a work memory to store programs to be executed by the CPU 111 or data being currently processed. More specifically, in one example, the DRAM 114 stores image data currently processed by the image processor 104 and data of the equirectangular projection image on which processing has been performed.

The operation unit 115 collectively refers to, for example, various operation buttons, a power switch, the shutter button, and a touch panel having both a display function and an operation function. The user operates the operation unit 115 to input various image capturing modes or image capturing conditions.

The input/output I/F 116 collectively refers to an interface circuit such as a USB I/F that allows the image capturing apparatus 10 to communicate with an external medium such as a Secure Digital (SD) card or an external personal computer. The input/output I/F 116 may be either wired or wireless. The data of the equirectangular projection image, which is stored in the DRAM 114, is stored in an external medium via the input/output I/F 116 or transmitted to an external terminal (or apparatus) via the input/output I/F 116, as desired.

The short-range communication circuit 117 communicates with an external terminal (or apparatus) via the antenna 117a of the image capturing apparatus 10 by short-range wireless communication technology such as near field communication (NFC), Bluetooth®, or Wi-Fi®. The short-range communication circuit 117 can transmit the data of the equirectangular projection image to an external terminal (or apparatus).

The electronic compass 118 calculates an orientation of the image capturing apparatus 10 from the Earth's magnetism and outputs orientation information. The orientation information is an example of related information (metadata) in compliance with exchangeable image file format (Exif). The orientation information is used for image processing such as image correction of a captured image. The related information also includes data of a date and time when the image was captured, and data of a data size of image data. The gyro sensor 119 detects changes in orientation of the image capturing apparatus 10, including roll, pitch, and yaw angles, as the image capturing apparatus 10 moves. The change in orientation is one example of related information (metadata) in compliance with Exif. This information is used for image processing such as image correction of a captured image. The acceleration sensor 120 detects acceleration in three axial directions. The image capturing apparatus 10 calculates the position of the image capturing apparatus 10 (e.g., the tilt of the image capturing apparatus 10 relative to the direction of gravity), based on the acceleration detected by the acceleration sensor 120. The gyro sensor 119 and the acceleration sensor 120 of the image capturing apparatus 10 improve the accuracy of image correction.

The network I/F 121 is an interface for performing data communication using the communication network N, such as the Internet, via a router.

### Hardware Configuration of Communication Terminal

FIG. 4 is a diagram illustrating an example hardware configuration of the communication terminal 30 and the information processing system 50. First, the communication terminal 30 will be described. Each hardware element of the communication terminal 30 is denoted by a reference numeral in 300 series. The communication terminal 30 is implemented by one or more computers. As illustrated in FIG. 4, the communication terminal 30 includes a CPU 301, a ROM 302, a RAM 303, a hard disk (HD) 304, a hard disk drive (HDD) controller 305, a display 306, an external device connection I/F 308, a network I/F 309, a bus line 310, a keyboard 311, a pointing device 312, a digital versatile disc rewritable (DVD-RW) drive 314, a media I/F 316, an audio input/output I/F 317, a microphone 318, a speaker 319, a short-range communication circuit 320, and a camera 321.

The CPU 301 controls the overall operation of the communication terminal 30. The ROM 302 stores a program used for booting the CPU 301, such as an initial program loader (IPL). The RAM 303 is used as a work area for the CPU 301. The HD 304 stores various types of data such as a program. The HDD controller 305 controls reading or writing of various types of data from or to the HD 304 under the control of the CPU 301. The display 306 displays various types of information such as a cursor, a menu, a window, characters, and an image. The display 306 is an example of a display unit. The display 306 may be a touch panel display provided with an input device. The external device connection I/F 308 is an interface for connecting to various external devices. The external devices include, but are not limited to, a USB memory and a printer. The network I/F 309 is an interface for performing data communication using the communication network N. The bus line 310 is, for example, an address bus or a data bus for electrically connecting the hardware elements illustrated in FIG. 4, such as the CPU 301, to each other.

The keyboard 311 is an example of an input device including a plurality of keys for inputting characters, numerical values, or various instructions. The pointing device 312 is an example of an input device used for selecting or executing various instructions, selecting a target for processing, or moving a cursor being displayed. The input device is not limited to the keyboard 311 and the pointing device 312 and may be a touch panel or an audio input device, for example. The DVD-RW drive 314 controls reading or writing of various types of data from or to a DVD-RW 313, which is an example of a removable recording medium. The DVD-RW 313 is an example, and a digital versatile disk recordable (DVD-R), a Blu-ray Disc®, or any other recording medium may be used instead. The media I/F 316 controls reading or writing (storing) of data from or to a recording medium 315 such as flash memory. The microphone 318 is an example of a built-in audio capturing device for receiving input sounds. The audio input/output I/F 317 is a circuit for controlling input and output of audio signals between the microphone 318 and the speaker 319 under the control of the CPU 301. The short-range communication circuit 320 communicates with an external terminal (or apparatus) using short-range wireless communication technology such as NFC, Bluetooth®, or Wi-Fi®. The camera 321 is an example of a built-in image capturing device for capturing an image of an object to obtain image data. In one example, the microphone 318, the speaker 319, and the camera 321 are devices external to the communication terminal 30 as an alternative to built-in devices.

### Hardware Configuration of Information Processing System

As illustrated in FIG. 4, each hardware element of the information processing system 50 is denoted by a reference numeral in 500 series in parentheses. The information processing system 50 is implemented by one or more computers and has substantially the same configuration as that of the communication terminal 30, as illustrated in FIG. 4, and thus the description of the hardware elements of the information processing system 50 will be omitted.

Each of the programs described above may be recorded as a file in a format installable or executable on a computer-readable recording medium for distribution. Examples of the recording medium include a compact disc recordable (CD-R), a digital versatile disc (DVD), a Blu-ray Disc®, an SD card, and a USB memory. The recording medium may be provided in the form of a program product to domestic or foreign users. For example, the communication terminal 30 executes a program according to an embodiment of the present disclosure to implement an information processing method according to an embodiment of the present disclosure.

### Wide-View Image and Point-of-View Information

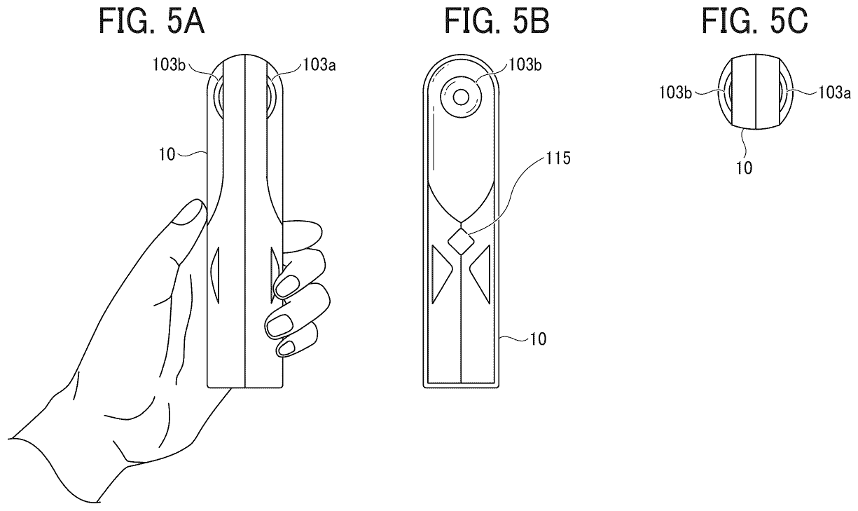

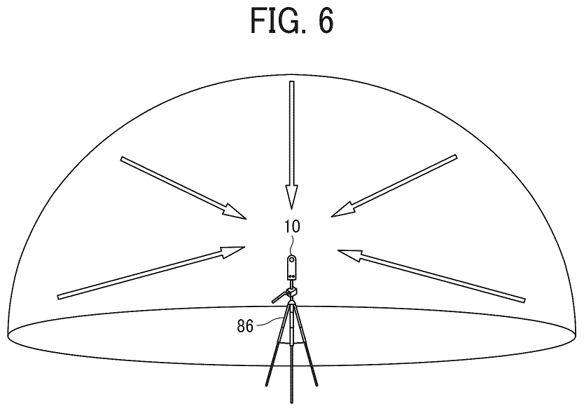

A method for generating a wide-view image (spherical image) will be described hereinafter with reference to FIGS. 5A to 12.

First, the external appearance of the image capturing apparatus 10 will be described with reference to FIGS. 5A to 5C. The image capturing apparatus 10 is a digital camera for capturing images from which a 360-degree spherical image is generated. FIG. 5A is a left side view of the image capturing apparatus 10. FIG. 5B is a front view of the image capturing apparatus 10. FIG. 5C is a plan view of the image capturing apparatus 10. The illustrated external view of the image capturing apparatus 10 is merely an example. The image capturing apparatus 10 may have any other external appearance.

As illustrated in FIG. 5A, the image capturing apparatus 10 has a size such that a person can hold the image capturing apparatus 10 with one hand. The illustrated shape of the image capturing apparatus 10 is an example. The image capturing apparatus 10 may have any other shape. As illustrated in FIGS. 5A, 5B, and 5C, the imaging element 103a and the imaging element 103b are disposed in an upper portion of the image capturing apparatus 10 such that the imaging element 103a is disposed on the front side and the imaging element 103b is disposed on the back side. The imaging elements (image sensors) 103a and 103b are used in combination with optical members (e.g., the lenses 102a and 102b described above), each being configured to capture a hemispherical image having an angle of view of greater than or equal to 180 degrees. As illustrated in FIG. 5B, the operation unit 115, such as a shutter button, is disposed on the back surface of the image capturing apparatus 10. As described above, the image capturing apparatus 10 may include one imaging element or three or more imaging elements.

Next, an example of use of the image capturing apparatus 10 will be described with reference to FIG. 6. FIG. 6 is an illustration of an example of how the image capturing apparatus 10 is used. As illustrated in FIG. 6, for example, the image capturing apparatus 10 is used for capturing an image of an object surrounding the image capturing apparatus 10. Each of the imaging elements 103a and 103b illustrated in FIGS. 5A to 5C captures an image of an object surrounding the image capturing apparatus 10. As a result, two hemispherical images are obtained.

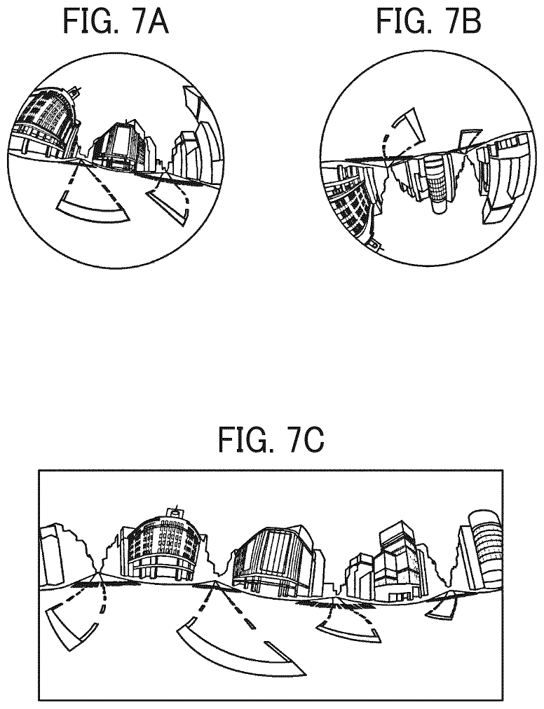

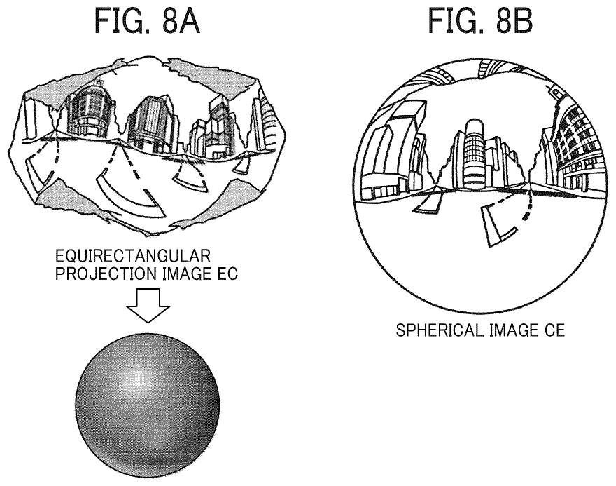

Next, an overview of a process for generating a spherical image from images captured by the image capturing apparatus 10 will be described with reference to FIGS. 7A to 7C and FIGS. 8A and 8B. FIG. 7A illustrates a hemispherical image (front side) captured by the image capturing apparatus 10. FIG. 7B illustrates a hemispherical image (back side) captured by the image capturing apparatus 10. FIG. 7C illustrates an image in equirectangular projection (hereinafter referred to as an “equirectangular projection image” or an “equidistant cylindrical projection image”). FIG. 8A conceptually illustrates how the equirectangular projection image is mapped to a surface of a sphere. FIG. 8B illustrates a spherical image.

As illustrated in FIG. 7A, an image obtained by the imaging element 103a is a curved hemispherical image (front side) captured through the lens 102a described above. As illustrated in FIG. 7B, an image captured by the imaging element 103b is a curved hemispherical image (back side) captured through the lens 102b described above. The image capturing apparatus 10 combines the hemispherical image (front side) and the hemispherical image (back side), which are flipped by 180 degrees, to create an equirectangular projection image EC as illustrated in FIG. 7C.

The image capturing apparatus 10 uses software such as OpenGL ES to map the equirectangular projection image EC to a sphere so as to cover the surface of the sphere, as illustrated in FIG. 8A. As a result, the image capturing apparatus 10 generates a spherical image (or spherical panoramic image) CE as illustrated in FIG. 8B. That is, the spherical image CE is represented as the equirectangular projection image EC, which corresponds to a surface facing the center of the sphere. OpenGL ES is a graphics library used for visualizing 2D data and 3D data. OpenGL ES is an example of software for executing image processing. Any other software may be used to create the spherical image CE. The spherical image CE may be either a still image or a moving image.

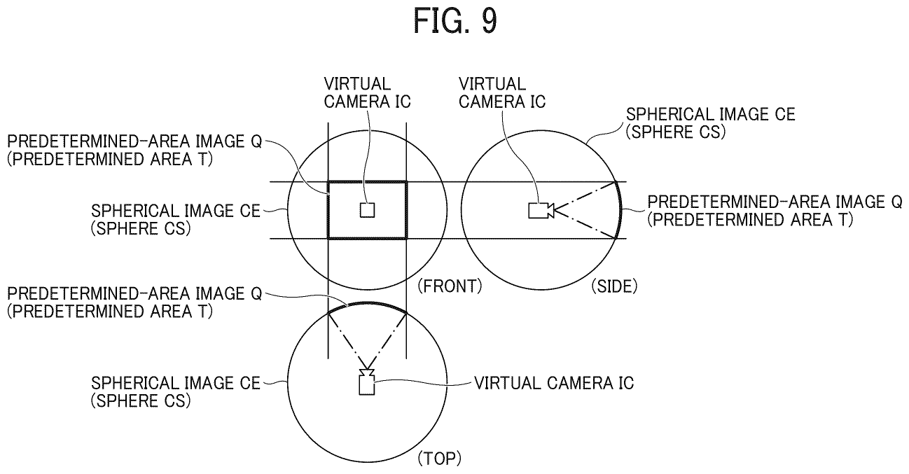

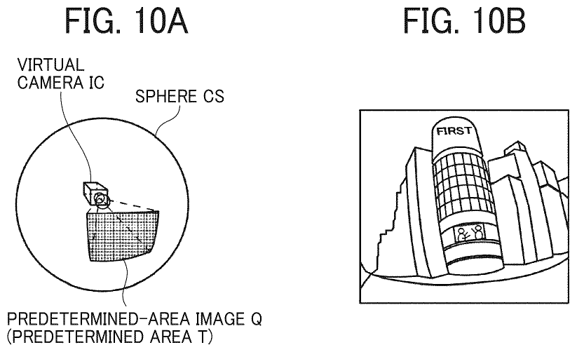

As described above, since the spherical image CE is an image mapped to a sphere so as to cover the surface of the sphere, part of the image may look distorted when viewed by a user, providing a strange feeling. Accordingly, the image capturing apparatus 10 displays an image of a predetermined area T, which is part of the spherical image CE, as a planar image having fewer curves to make the user feel comfortable. The predetermined area is, for example, a part of the spherical image CE that is viewable by the user. In this disclosure, the image of the predetermined area, which is viewable, may be referred to as a “predetermined-area image” or “viewable-area image” Q. That is, the terms “predetermined-area image” and “viewable-area image” may be used interchangeably. The display of the predetermined-area image will be described with reference to FIGS. 9, 10A, and 10B.

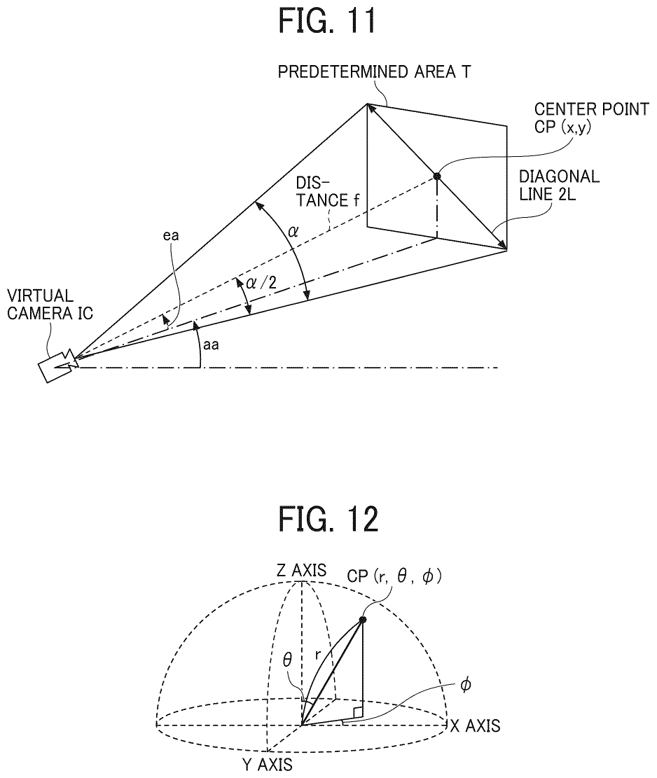

FIG. 9 is a diagram illustrating the position of a virtual camera IC and the position of the predetermined area T in a case where the spherical image CE is of a three-dimensional sphere CS. The position of the virtual camera IC corresponds to the position of a point of view (viewpoint) of a user who is viewing the spherical image CE represented as a surface area of the three-dimensional solid sphere CS. FIG. 10A is a perspective view of the virtual camera IC and the predetermined area T illustrated in FIG. 9, and FIG. 10B is a diagram illustrating a predetermined-area image displayed on a display. In FIG. 10A, the spherical image CE illustrated in FIG. 9 is represented by the three-dimensional sphere CS. Assuming that the spherical image CE generated in the way described above is a surface area of the sphere CS, the virtual camera IC is inside the spherical image CE as illustrated in FIG. 9. The predetermined area T in the spherical image CE is an imaging area of the virtual camera IC. Specifically, the predetermined area T is specified by predetermined-area information indicating an imaging direction and an angle of view of the virtual camera IC in a three-dimensional virtual space containing the spherical image CE. Zooming in or out of the predetermined area T may be implemented by bringing the virtual camera IC closer to or farther away from the spherical image CE. The predetermined-area image Q is an image of the predetermined area T in the spherical image CE. The predetermined area T is defined by an angle of view α of the virtual camera IC and a distance f from the virtual camera IC to the spherical image CE (see FIG. 11).

The predetermined-area image Q illustrated in FIG. 10A is displayed on a predetermined display as an image of the imaging area of the virtual camera IC, as illustrated in FIG. 10B. The image illustrated in FIG. 10B is a predetermined-area image represented by predetermined-area information that is set by default. A description will be made using the imaging direction (ea, aa) and the angle of view (α) of the virtual camera IC. In another example, the predetermined area T is not defined by the angle of view α and the distance f, and the imaging area of the virtual camera IC, which is the predetermined area T, is identified by position coordinates (X, Y, Z).

Next, the relationship between the predetermined-area information and the image of the predetermined area T will be described with reference to FIG. 11. FIG. 11 is a diagram illustrating the relationship between the predetermined-area information and the image of the predetermined area T. As illustrated in FIG. 11, “ea” denotes an elevation angle, “aa” denotes an azimuth angle, and “a” denotes an angle of view of the virtual camera IC. The position of the virtual camera IC is adjusted such that the point of gaze of the virtual camera IC, indicated by the imaging direction (ea, aa), matches a center point CP (x, y) of the predetermined area T serving as the imaging area of the virtual camera IC. As illustrated in FIG. 11, the center point CP (x, y) of the predetermined area T, whose diagonal angle of view is represented by the angle of view α of the virtual camera IC and is denoted by α, is used as a parameter (x, y) of the predetermined-area information. The predetermined-area image Q is an image of the predetermined area T in the spherical image CE. The distance f is the distance from the virtual camera IC to the center point CP (x, y) of the predetermined area T. The distance between the center point CP (x, y) and a given vertex of the predetermined area T is denoted by “L” (2L is a diagonal line). In FIG. 11, a trigonometric function generally expressed by Equation (1) below holds.

$$L / f = tan ( \frac{α}{2} ) \qquad ( 1 )$$

The image capturing apparatus 10 described above is an example of an image capturing apparatus for acquiring a wide-view image. The spherical image CE is an example of a wide-view image. The wide-view image is generally an image captured with a wide-angle lens such as a lens that can capture an image of a range wider than a range that the human eye can perceive.

FIG. 12 is a diagram illustrating the relationship illustrated in FIG. 11 using a point in a three-dimensional Euclidean space defined in spherical coordinates. The center point CP illustrated in FIG. 11 is represented by a spherical polar coordinate system to obtain position coordinates (r, θ, φ). The position coordinates (r, θ, φ) represent a radius vector, a polar angle, and an azimuth angle, respectively. The radius vector r is the distance from the origin of the three-dimensional virtual space including the spherical image CE to the center point CP. Accordingly, the radius vector r is equal to the distance f illustrated in FIG. 11. FIG. 12 illustrates the relationship illustrated in FIG. 11. In the following description, the position coordinates (r, θ, φ) of the virtual camera IC are used as an example of point-of-view information. As described above, the point-of-view information is any parameter information that can define the predetermined area T (the predetermined-area image Q) displayed on the predetermined display illustrated in FIG. 10A as the image of the imaging area of the virtual camera IC. The point-of-view information includes the coordinates of the diagonal vertices of the predetermined area T. Information indicating the angle of view α of the virtual camera IC and information indicating the center point CP (x, y), which have been described with reference to FIG. 11, may be represented by the point-of-view information. Examples of the point-of-view information include position coordinate information in the form of spherical coordinates, position coordinate information in the form of orthogonal coordinates, and a difference value between the predetermined-area information that is set by default and the coordinates. Other examples of the point-of-view information include information other than coordinate information, such as an angle and a distance, as illustrated in FIG. 11. In FIGS. 11 and 12, the center point CP of the predetermined area T is used as a reference. In another example, the predetermined area T may be defined by parameter information with any one of the vertices of the predetermined area T as a reference. In the foregoing description of the point-of-view information, as a non-limiting example, the wide-view image is a spherical image. In another wide-view image, information that defines the predetermined area T in the other wide-view image is point-of-view information.

### Functions

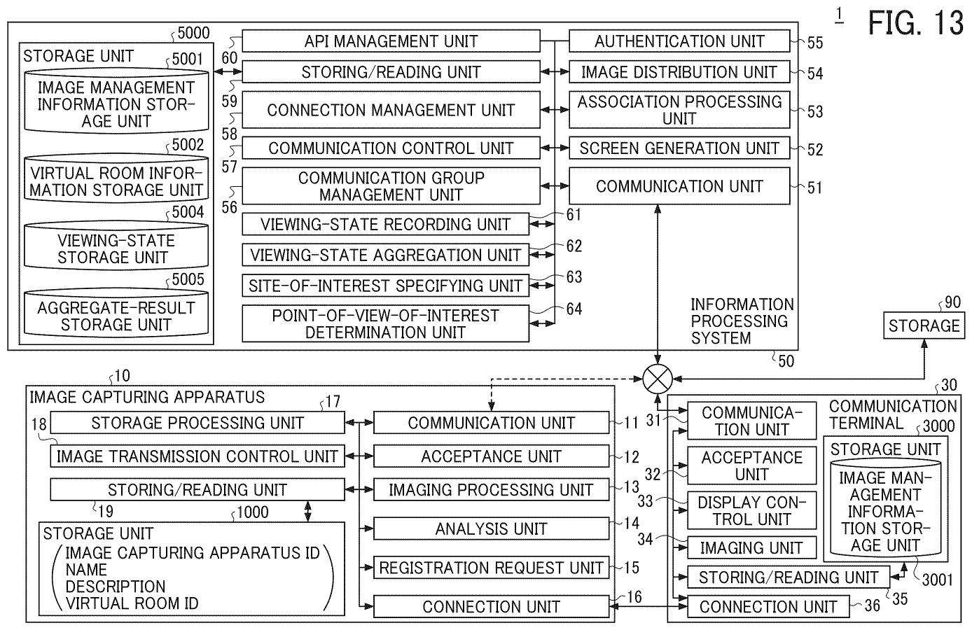

Next, the functional configuration of the communication system 1 according to the present embodiment will be described with reference to FIG. 13. FIG. 13 is a diagram illustrating an example functional configuration of the communication system 1 according to the present embodiment. FIG. 13 illustrates functions, related to processes or operations described below, of the terminals, the apparatuses, and the server illustrated in FIG. 1.

### Functional Configuration of Image Capturing Apparatus

First, the functional configuration of the image capturing apparatus 10 will be described with reference to FIG. 13. The image capturing apparatus 10 includes a communication unit 11, an acceptance unit 12, an imaging processing unit 13, an analysis unit 14, a registration request unit 15, a connection unit 16, a storage processing unit 17, an image transmission control unit 18, and a storing/reading unit 19. Each unit is a function or means implemented by or caused to function by one or more of the hardware elements illustrated in FIG. 3 operating in accordance with instructions from the CPU 111 according to a program loaded onto the SRAM 113 or the DRAM 114. The image capturing apparatus 10 further includes a storage unit 1000, which is implemented by, for example, the ROM 112 illustrated in FIG. 3.

The communication unit 11 has a function of connecting to the communication network N by using wireless communication technology such as Wi-Fi® to transmit and receive various types of data or information to and from another apparatus. In the present embodiment, the connection unit 16 transmits a wide-view image acquired by the imaging processing unit 13 to the information processing system 50, by way of example. In another example, the communication unit 11 may transmit the wide-view image to the information processing system 50.

The acceptance unit 12 has a function of receiving an operation input for the image capturing apparatus 10 from the user. The acceptance unit 12 accepts an operation for turning on or off the power, pressing or releasing the shutter button (to start or stop transmission of a wide-view image), or any other operation.

The imaging processing unit 13 captures an image of an object or surroundings such as scenery and acquires a captured image. The captured image acquired by the imaging processing unit 13 may be either a moving image or a still image, or both. In another example, the captured image may include audio together with an image. Further, for example, the imaging processing unit 13 captures an image of a two-dimensional code displayed on the display 306 of the communication terminal 30.

The analysis unit 14 analyzes the two-dimensional code, which is obtained from an image captured by the imaging processing unit 13, and extracts information included in the two-dimensional code. The extracted information includes a URL for registering the image capturing apparatus 10 in the tenant, a temporary ID, and a password.

The registration request unit 15 transmits a request to the information processing system 50 to register the image capturing apparatus 10 in the tenant in the information processing system 50, by using the information included in the two-dimensional code read by the analysis unit 14.

The connection unit 16 has a function of receiving a supply of power from the communication terminal 30A and performing data communication. The connection unit 16 is implemented by, for example, the short-range communication circuit 117.

The storage processing unit 17 performs processing to store a wide-view image captured in response to an image capturing request from any site in a location specified by a URL (e.g., the storage 90) transmitted from the information processing system 50.

The image transmission control unit 18 has a function of controlling transmission of a wide-view image to the information processing system 50. For example, the image transmission control unit 18 transmits a captured image acquired by the imaging processing unit 13 to the information processing system 50 periodically or in response to a user operation when the captured image is a still image, or at a predetermined frame rate (expressed in frames per second, or FPS) when the captured image is a moving image. The image transmission control unit 18 also performs switching between the communication unit 11 and the connection unit 16.

The storing/reading unit 19 has a function of storing various types of data in the storage unit 1000 or reading various types of data from the storage unit 1000. The storage unit 1000 stores, for example, captured image data acquired by the imaging processing unit 13, and an image capturing apparatus ID. The captured image data stored in the storage unit 1000 may be deleted when a predetermined amount of time has elapsed after the captured image data was acquired by the imaging processing unit 13, or the data transmitted to the information processing system 50 may be deleted from the storage unit 1000.

The image capturing apparatus 10 has installed therein an application (also referred to as a plug-in) for supporting the communication system 1. The application is not used when the image capturing apparatus 10 is a commercially available image capturing apparatus, but otherwise is used to associate the image capturing apparatus 10 with a virtual room or to receive external control. Some of the functions illustrated in FIG. 13, such as the registration request unit 15, are implemented by the application.

### Functional Configuration of Communication Terminal

Next, the functional configuration of the communication terminal 30 will be described with reference to FIG. 13. The communication terminal 30 includes a communication unit 31, an acceptance unit 32, a display control unit 33, an imaging unit 34, a storing/reading unit 35, and a connection unit 36. Each unit is a function or means implemented by or caused to function by one or more of the hardware elements illustrated in FIG. 4 operating in accordance with instructions from the CPU 301 according to a program (either the web browser or a dedicated application) loaded onto the RAM 303. The communication terminal 30 further includes a storage unit 3000, which is implemented by the ROM 302 or the recording medium 315 illustrated in FIG. 4.

The communication unit 31 has a function of connecting to the communication network N and transmitting and receiving various types of data or information to and from another apparatus. The communication unit 31 is implemented by, for example, the network I/F 309.

The acceptance unit 32 has a function of receiving various selections or operation inputs for the communication terminal 30. The display control unit 33 has a function of causing the display 306 of the communication terminal 30 to display a wide-view image, an image having a normal angle of view, and various screens. For example, the display control unit 33 causes the display 306 to display a two-dimensional code transmitted from the information processing system 50. In one example, the two-dimensional code is a QR code®, a DataMatrix (DataCode) code, a MaxiCode code, or a PDF417 code. In another example, the two-dimensional code is a barcode.

The connection unit 36 has a function of supplying power to the image capturing apparatus 10 and performing data communication. The connection unit 36 is implemented by, for example, the short-range communication circuit 320.

The storing/reading unit 35 has a function of storing various types of data in the storage unit 3000 or reading various types of data from the storage unit 3000 in accordance with instructions from the CPU 301 illustrated in FIG. 4. The storage unit 3000 includes an image management information storage unit 3001. The image management information stored in the image management information storage unit 3001 will be described in the description of the information processing system 50.

### Functional Configuration of Information Processing System

Next, the functional configuration of the information processing system 50 will be described. The information processing system 50 includes a communication unit 51, a screen generation unit 52, an association processing unit 53, an image distribution unit 54, an authentication unit 55, a communication group management unit 56, a communication control unit 57, a connection management unit 58, a storing/reading unit 59, an API management unit 60, a viewing-state recording unit 61, a viewing-state aggregation unit 62, a site-of-interest specifying unit 63, and a point-of-view-of-interest determination unit 64. Each unit is a function or means implemented by or caused to function by one or more of the hardware elements illustrated in FIG. 4 operating in accordance with instructions from the CPU 501 according to a program loaded onto the RAM 503. The information processing system 50 further includes a storage unit 5000, which is implemented by the ROM 502, the HD 504, or the recording medium 515 illustrated in FIG. 4.

The communication unit 51 has a function of transmitting and receiving various types of data or information to and from another apparatus via the communication network N.

The screen generation unit 52 generates screen information to be displayed on the communication terminal 30. In a case where the communication terminal 30 executes a web application, the screen information is created by Hypertext Markup Language (HTML), Extensible Markup Language (XML), Cascading Style Sheets (CSS), JavaScript®, or any other language. In a case where the communication terminal 30 executes a native application, the screen information is held by the communication terminal 30, and the information to be displayed is transmitted in, for example, XML. The screen generation unit 52 generates screen information in which a wide-view image to be distributed by the image distribution unit 54 is arranged.

The association processing unit 53 performs control related to sharing of point-of-view information of a wide-view image. In response to receipt of an image capturing request together with point-of-view information from the communication terminal 30, the association processing unit 53 performs processing to associate the point-of-view information with a wide-view image acquired from the image capturing apparatus 10 in response to an image capturing request. The association processing unit 53 stores the wide-view image and the point-of-view information, which are associated with each other, in an image management information storage unit 5001. Further, the association processing unit 53 transmits a URL, which is information indicating a storage location where the associated wide-view image and point-of-view information are to be stored, to the communication terminal 30. In one example, the information processing system 50 does not simultaneously receive the point-of-view information and the image capturing request from the communication terminal 30. The information processing system 50 may separately receive the point-of-view information and the image capturing request and perform association processing. The URL is an example of information indicating the storage location. The information indicating the storage location may be in any other format such as a uniform resource identifier (URI).

The image distribution unit 54 distributes, to the communication terminal 30 operated by a user who is in the virtual room, a wide-view image transmitted from the image capturing apparatus 10 associated with the same virtual room. An image having a normal angle of view captured by a camera included in the communication terminal 30 or the image capturing apparatus 8 or 9 connected to the communication terminal 30 is also distributed in a similar manner.

In the following description, an image distributed from the information processing system 50 to the communication terminals 30 at the respective sites may be referred to as a distribution image, and image data indicating the distribution image may be referred to as distribution image data. In the present embodiment, distribution image data represents video (or a moving image) with a plurality of consecutive frames. In the present embodiment, a distribution image is an image for each of the frames in the distribution image data. Screen information for displaying a distribution image is generated by the screen generation unit 52. The distribution image data may represent a still image.

The distribution image includes images of a plurality of sites at which users who have entered and are currently in the same virtual room are located. An image of each site is an image captured by the image capturing apparatus 8 or 9 provided at the site.

The images of the sites included in the distribution image include images having a normal angle of view captured at a plurality of sites at which users who have entered and are currently in the same virtual room are located, and a wide-view image captured by the image capturing apparatus 10 associated with the virtual room. In the following description, an image having a normal angle of view may be referred to as a normal-angle-of-view image, and image data indicating the normal-angle-of-view image may be referred to as normal-angle-of-view image data. In the following description, image data indicating a wide-view image may be referred to as wide-view image data.

The authentication unit 55 has a function of, based on an authentication request received by the communication unit 51, authenticating the request source. For example, the authentication unit 55 determines whether authentication information (a user ID and a password) included in the authentication request received by the communication unit 51 matches authentication information held in advance to perform user authentication. The authentication information may be a card number of an integrated circuit (IC) card or biometric authentication information such as a face, a fingerprint, or a voiceprint. The authentication unit 55 may perform authentication using an external authentication system or an authentication method such as Open Authorization (OAuth).

The communication group management unit 56 manages, for example, the entry of the communication terminal 30 or the user into the virtual room, and association between the virtual room and a device. When authentication by the authentication unit 55 is successful, the communication group management unit 56 registers the user ID and the Internet protocol (IP) address of the communication terminal 30 in a virtual room information storage unit 5002 or associates the image capturing apparatus 10 with the virtual room.

The communication control unit 57 manages the start, establishment, and end of communication with the image capturing apparatus 10 associated with each virtual room. The communication control unit 57 also manages the start, establishment, and end of communication for distributing a wide-view image or audio in accordance with entry of and exit from the virtual room by the communication terminal 30.

The connection management unit 58 manages communication (connection) established with the information processing system 50 by the communication terminal 30 and the image capturing apparatus 10 in association with the virtual room.

The API management unit 60 manages an API to be used by a platform contractor to provide an image distribution service of a wide-view image. In the use of the API, the platform contractor develops software for calling the API. The software to be developed may operate on a server or may operate on a client such as a communication terminal.

Any functions of the information processing system 50, such as the image distribution unit 54, the association processing unit 53, and the communication control unit 57, can be provided as an API. A function added to the information processing system 50 later may be provided as an API. To determine whether to provide a function as an API, a communication terminal operated by the platform provider accesses the information processing system 50 and receives the public settings of the API. As a result, the API management unit 60 can control the API based on the public settings. The API management unit 60 may perform an authentication process for checking whether software operating on a requesting entity that makes a request to call the API is software developed by an authorized platform contractor.

The authentication process can be performed by comparing information stored in the storage unit 5000 with information transmitted from the software operating on the requesting entity. In a specific example of the authentication process, the information processing system 50 receives, from the software operating on the requesting entity, an application ID issued to the software developed by the platform contractor in advance by the API management unit 60. If the API management unit 60 determines that the application ID matches an application ID stored in the storage unit 5000, the API management unit 60 performs control to permit provision of the API since the software is valid.

If the software is not determined to be valid, the API management unit 60 performs control not to permit provision of the API. The application ID is an example of authentication information for determining validity. The API management unit 60 may use authentication information issued in advance by the API management unit 60 of the information processing system 50 or by an external system to check the validity of the requesting entity. Examples of such authentication information as issued in advance include an access token, a ticket, a security key, a password, and a personal identification number (PIN) code. In the present embodiment, while the use of a function of the information processing system 50 as an API is not described, the same process flow is performed, except that software such as an application developed by a platform contractor uses a function of the information processing system 50 through a determination made by the API management unit 60.

The storing/reading unit 59 has a function of storing various types of data in the storage unit 5000 or reading various types of data from the storage unit 5000. The storage unit 5000 includes the image management information storage unit 5001, the virtual room information storage unit 5002, a viewing-state storage unit 5004, and an aggregate-result storage unit 5005.

The viewing-state recording unit 61 stores viewing-state information in the viewing-state storage unit 5004 provided in the storage unit 5000. Specifically, information indicating a site being focused on by the communication terminal 30 at each site is set as viewing-state information, and the viewing-state recording unit 61 stores the viewing-state information in the viewing-state storage unit 5004 in association with distribution image data to be transmitted to the communication terminals 30 at the respective sites. The viewing-state information is associated with the distribution image data by, for example, a virtual room ID of the virtual room that the communication terminals 30 at the respective sites are in.

The site being focused on is, for example, a site at which an image displayed in an enlarged manner is captured among images of a plurality of sites included in a distribution image displayed on the communication terminal 30 at each site.

When the distribution image includes a wide-view image, point-of-view information indicating a point of view being focused on in the wide-view image is set as viewing-state information, and the viewing-state recording unit 61 stores the viewing-state information in the viewing-state storage unit 5004 in association with distribution image data to be transmitted to the communication terminals 30 at the respective sites.

The point of view being focused on is, for example, a point of view designated in the wide-view image displayed on the communication terminal 30 at each site. In the following description, information indicating a site being focused on is referred to as site-of-interest information, and point-of-view information indicating a point of view designated in the wide-view image is referred to as designated-point-of-view information.

That is, in the present embodiment, the viewing-state information includes site-of-interest information indicating another site being focused on by the communication terminal 30 at each site that has entered and is currently in the virtual room, and designated-point-of-view information indicating a point of view designated in the wide-view image at each site at which the communication terminal 30 that has entered and is currently in the virtual room is located.

The viewing-state aggregation unit 62 aggregates viewing-state information stored in the viewing-state storage unit 5004, and stores aggregate-result information indicating an aggregate result in the aggregate-result storage unit 5005. Specifically, the viewing-state aggregation unit 62 aggregates, for each timestamp of the time of distributing distribution image data, the number of other sites focusing on each site, based on the site-of-interest information included in the viewing-state information. The viewing-state aggregation unit 62 stores the result of the aggregation as number-of-sites-of-interest information in the aggregate-result storage unit 5005.

In accordance with the result of the aggregation by the viewing-state aggregation unit 62, the site-of-interest specifying unit 63 specifies, for each timestamp of the time of distributing distribution image data, a site being focused on by the largest number of sites at that time. In the following description, a site being focused on by the largest number of sites is referred to as a site of highest interest.

The point-of-view-of-interest determination unit 64 determines, for each timestamp of the time of distributing distribution image data, a point of view having the highest level of interest in the wide-view image, based on the designated-point-of-view information included in the viewing-state information. The point of view determined by the point-of-view-of-interest determination unit 64 indicates a point of view having the highest level of interest at the time indicated by the timestamp. In the following description, a point of view having the highest level of interest is referred to as a point of view of highest interest, and point-of-view information indicating the point of view of highest interest is referred to as point-of-view-of-highest-interest information.

The point-of-view-of-interest determination unit 64 stores the point-of-view-of-highest-interest information in the aggregate-result storage unit 5005 as part of the aggregate-result information. Accordingly, the aggregate-result information stored in the aggregate-result storage unit 5005 includes the number-of-sites-of-interest information and the point-of-view-of-highest-interest information.

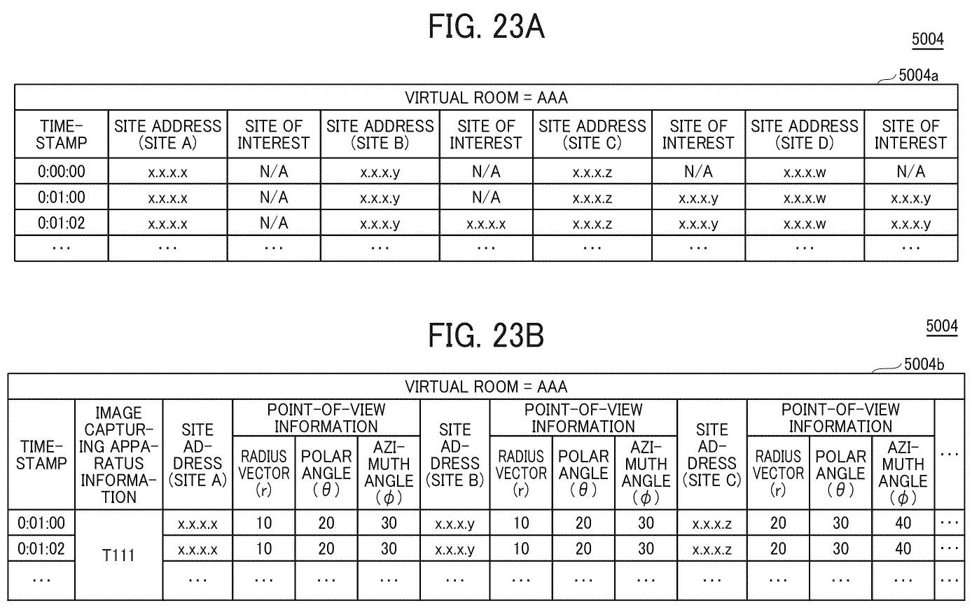

The point-of-view-of-interest determination unit 64 calculates a centroid from, for example, points of view indicated by point-of-view information of all sites included in designated-point-of-view information 5004b (see FIG. 23B), and determines a point of view closest to the centroid as the point of view of highest interest. A method for determining the point of view of highest interest in the present embodiment is merely an example and is not limited thereto.

To generate screen information indicating a distribution image, the screen generation unit 52 refers to the number-of-sites-of-interest information stored in the aggregate-result storage unit 5005. The screen generation unit 52 generates the screen information such that the site of highest interest for each timestamp can be recognized by the users of the communication terminals 30 at the respective sites. To generate screen information indicating a distribution image, the screen generation unit 52 further refers to the point-of-view-of-highest-interest information stored in the aggregate-result storage unit 5005. The screen generation unit 52 generates the screen information such that the point of view of highest interest for each timestamp can be recognized by the users of the communication terminals 30 at the respective sites.

In the present embodiment, generating the screen information allows a site of highest interest and a point of view of highest interest to be displayed in a distribution image on the communication terminals 30 at the respective sites during distribution of distribution image data to the communication terminals 30 at the respective sites. Accordingly, the present embodiment allows a user of the communication terminal 30 at each site to identify a site and a point of view being focused on by the users of the communication terminals 30 at the other sites.

In the information processing system 50, the storing/reading unit 59 stores the distribution image data in a storage destination indicated by data storage location information included in image management information described below. Storing the distribution image data allows a user of the communication terminal 30 to review the distribution image data after the distribution image data has been distributed.

In the information processing system 50, furthermore, even when a user reviews the distribution image data using the communication terminal 30, the viewing-state information associated with the distribution image data can be used to identify, for each timestamp, a site and a point of view that are focused on by users of the communication terminals 30 at other sites, in a manner similar to that during distribution.

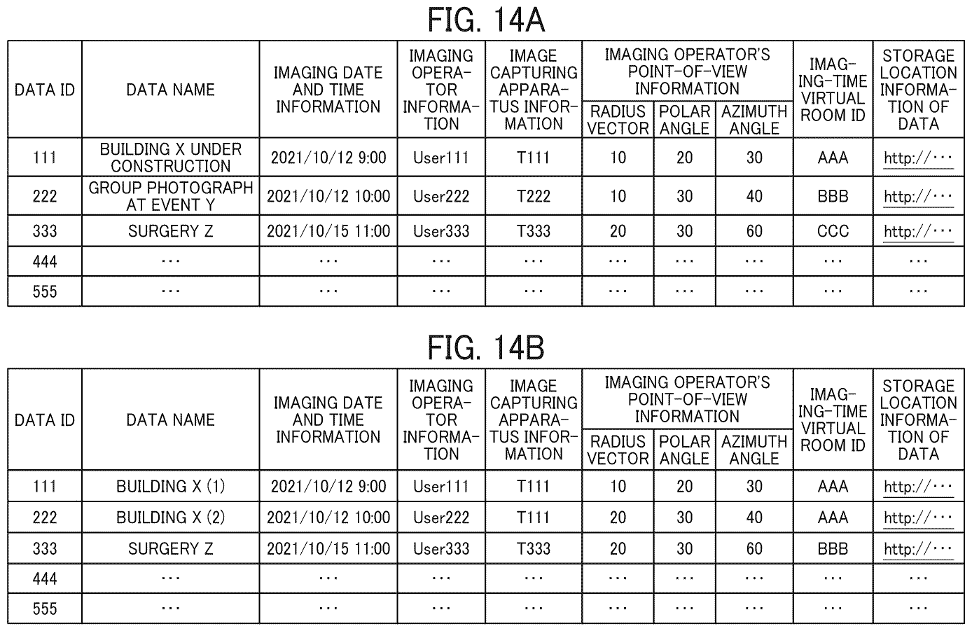

The image management information storage unit 5001 will be described hereinafter with reference to FIGS. 14A and 14B. FIG. 14A is an illustration of image management information stored in the image management information storage unit 5001. The image management information storage unit 5001 stores image management information as illustrated in FIG. 14A or 14B. The image management information is information for managing wide-view images captured in response to image capturing requests. In response to a user transmitting an image capturing request from the communication terminal 30, image management information for one record is generated. The items included in the image management information will be described.

The item “data ID” represents identification information that identifies a wide-view image. The information processing system 50 assigns a number to each data ID. ID is an abbreviation for identification and refers to an identifier or identification information. The ID is any one or a combination of two or more of a name, a symbol, a character string, and a numerical value that are used for uniquely identifying a specific object from among a plurality of objects.

The item “data name” represents the name of a wide-view image set by the user of the communication terminal 30. Each data name may be set by a user or automatically.

The item “imaging date and time information” represents information that specifies the imaging date and time of a wide-view image. Examples of the imaging date and time include the date and time when the user input an image capturing request to the communication terminal 30, and the date and time when the image capturing apparatus 10 captured a wide-view image. The imaging date and time information may be a timestamp of a wide-view image.

The item “imaging operator information” represents identification information (or a user name) of a user (imaging operator) who has input an image capturing request to the communication terminal 30. Since a user inputs an image capturing request to the communication terminal 30 after entering a virtual room, a user registered in the imaging operator information is identified by authentication for the information processing system 50 or the virtual room. The imaging operator information is transmitted to the information processing system 50 together with an image capturing request.

The item “image capturing apparatus information” represents identification information (image capturing apparatus ID) of the image capturing apparatus 10 that has captured a wide-view image. The information processing system 50 assigns a number to each image capturing apparatus ID and shares the image capturing apparatus ID with the image capturing apparatus 10. The image capturing apparatus ID may be information unique to the image capturing apparatus 10, such as a MAC address or a serial number. The image capturing apparatus ID is transmitted to the information processing system 50 together with the associated wide-view image.

The item “imaging operator's point-of-view information” represents point-of-view information including a radius vector, a polar angle, and an azimuth angle. The point-of-view information indicates the coordinates of the center of the wide-view image that is being displayed on the communication terminal 30. The point-of-view information is transmitted from the communication terminal 30 that makes an image capturing request. The point-of-view information may include information designating the width and height of the display range, in addition to the radius vector, the polar angle, and the azimuth angle. Alternatively, the point-of-view information may include the width and height of the display range, instead of the radius vector, the polar angle, and the azimuth angle.

The item “imaging-time virtual room ID” represents identification information of a virtual room associated with the image capturing apparatus 10.

The item “storage location information of data” represents a URL or a file path of a location where a wide-view image is stored.

FIG. 14B is also an illustration of image management information. In FIG. 14B, wide-view images having the same imaging-time virtual room ID are stored. The image management information may be classified in units of virtual rooms.

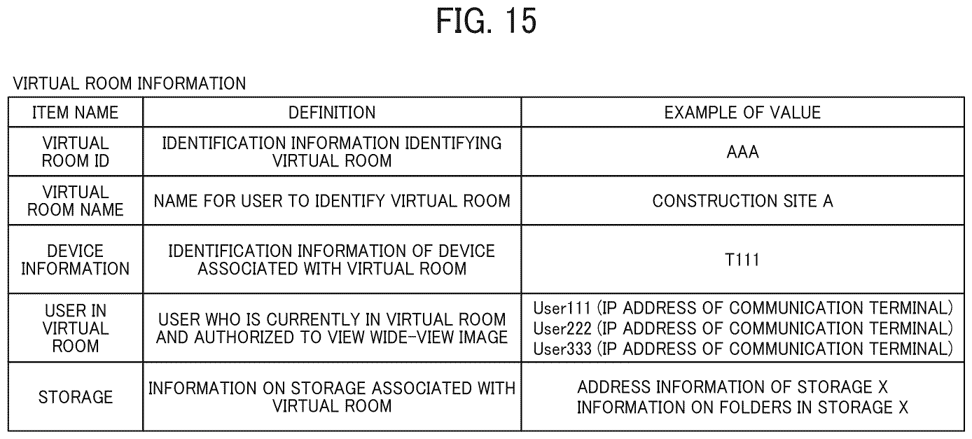

The virtual room information storage unit 5002 will be described hereinafter with reference to FIG. 15. FIG. 15 is an illustration of virtual room information stored in the virtual room information storage unit 5002. The virtual room information storage unit 5002 stores virtual room information as illustrated in FIG. 15. The virtual room information is information related to a virtual room. The virtual room information is held for each virtual room. The items included in the virtual room information will be described. The virtual room is registered in a tenant.

The item “virtual room ID” represents identification information that uniquely identifies a virtual room. In the present embodiment, each virtual room may be created by a user as appropriate.

The item “virtual room name” represents a name for a user to identify a virtual room. Each virtual room name may be set by the user as appropriate.

The item “device information” represents identification information (image capturing apparatus ID) of the image capturing apparatus 10 associated with the virtual room.

The item “user in virtual room” represents the user IDs of users who have entered and are currently in the virtual room. The users are authorized to view α wide-view image. The method for entering a virtual room will be described below. The user IDs are associated with the IP addresses of the communication terminals 30 operated by the users.

Entry of Communication Terminal into Virtual Room

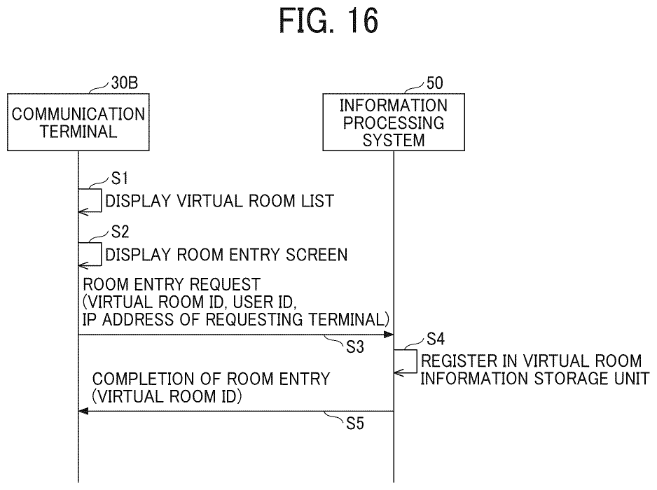

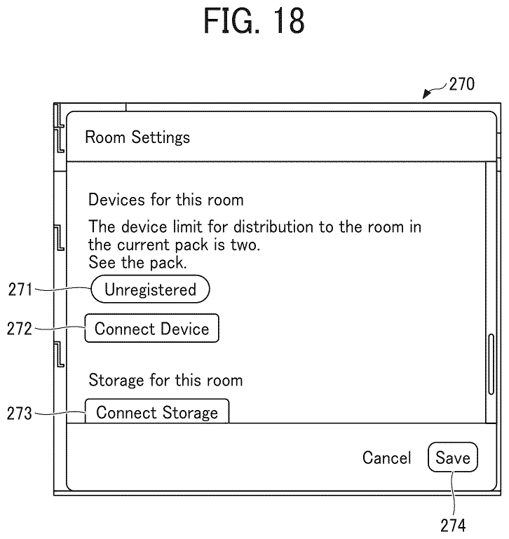

Next, a process in which the user B enters a virtual room will be described with reference to FIG. 16. In the illustrated example, the image capturing apparatus 10 has already been associated with the virtual room, and the communication terminal 30A has transmitted a wide-view image and an image having a normal angle of view to the information processing system 50. The association of the image capturing apparatus 10 with the virtual room and other operations will be described with reference to FIG. 18 and the subsequent drawings. In the following description, no distinction is made between the entry of the user B into the virtual room and the entry of the communication terminal 30B, which is operated by the user B, into the virtual room.

FIG. 16 is a sequence diagram illustrating a process in which the user B (or the communication terminal 30B) enters a virtual room.
S1: First, the user B at the site B performs an operation for displaying a virtual room list screen. In response to the acceptance unit 32 accepting the operation for displaying the virtual room list screen, the display control unit 33 of the communication terminal 30B causes the display 306 to display a selection screen.
S2: In response to the user B selecting a selection button for one of the virtual rooms, the acceptance unit 32 of the communication terminal 30B accepts the selection of the virtual room. The display control unit 33 of the communication terminal 30B causes the display 306 to display a room entry screen.
S3: The user B completes the items and then presses a room entry button on the room entry screen. In response to the acceptance unit 32 accepting the pressing of the room entry button, the communication unit 31 of the communication terminal 30B transmits a request to the information processing system 50 to enter the virtual room. The request for entering the virtual room includes a virtual room ID indicating the virtual room selected in step S2, the user ID of the user B, who is a login user, and the IP address of the communication terminal 30B from which the request is transmitted.
S4: The communication unit 51 of the information processing system 50 receives the request for entering the virtual room. The communication group management unit 56 registers the user ID of the login user (i.e., the user B) and the IP address of the communication terminal 30B in the virtual room information identified by the virtual room ID in the virtual room information storage unit 5002.
S5: The communication unit 51 of the information processing system 50 transmits, to the communication terminal 30B, a notification of the completion of the entry into the virtual room. Thus, the communication unit 31 of the communication terminal 30B receives the notification of the completion of the entry into the virtual room.

A process for associating the image capturing apparatus 10 with the virtual room will now be described. In the following description, by way of example, the communication system 1 is applied to a construction site. In this case, the site A is a construction site, and each of the sites B and C is any place where communication with the site A is possible, such as an office. In the construction site, workers are involved in various constructions at various locations. When the communication system 1 is applied to a construction site, the users A to C at the sites A to C can check any construction or work of interest by changing a virtual point of view as appropriate for a wide-view image that is a captured image of the entire construction site.

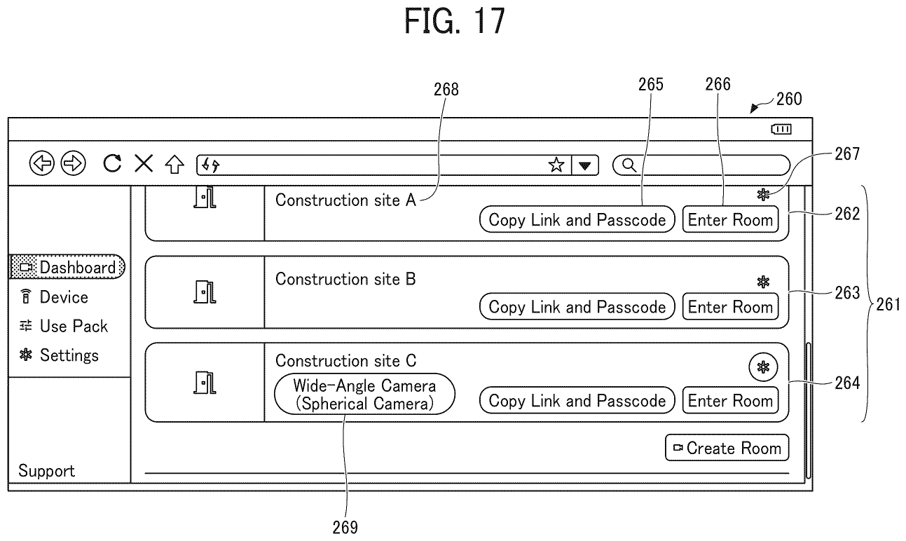

FIG. 17 illustrates an example of a virtual room association screen 260 for associating the image capturing apparatus 10 with a virtual room. The same screen configuration may be used for the VR goggles 89 and the smart glasses 88. The virtual room association screen 260 includes a virtual room list 261. The virtual room list 261 displays individual virtual room fields 262 to 264, based on virtual rooms created for respective construction sites.

Each of the individual virtual room fields 262 to 264 includes a link issuance button 265, a room entry button 266, a settings button 267, and a virtual room name 268. The link issuance button 265 is a button for issuing a link (a URL for invitation) to the corresponding virtual room and a passcode. The room entry button 266 is a button for the user A to enter the virtual room. The settings button 267 is a button for associating the image capturing apparatus 10 with the corresponding virtual room. The virtual room name 268 is the same as that stored in the virtual room information storage unit 5002. The user A presses the settings button 267. In response to the pressing of the settings button 267, the communication terminal 30A displays a virtual room association screen 270.

If a device has already been associated with the virtual room, a name 269 of the device is displayed in the individual virtual room field (in FIG. 17, the individual virtual room field 264).

FIG. 18 illustrates an example of the virtual room association screen 270. The virtual room association screen 270 is displayed as a pop-up on the virtual room association screen 260. The screen transition from the virtual room association screen 260 to the virtual room association screen 270 is not made through the information processing system 50. In another example, the screen transition from the virtual room association screen 260 to the virtual room association screen 270 may be made through the information processing system 50.

The virtual room association screen 270 includes a name 271 of the image capturing apparatus 10 that is currently (or has already been) associated with the virtual room, a connection button 272, a storage button 273, and a “Save” button 274. In FIG. 18, the name 271 is set as “unregistered” because the image capturing apparatus 10 is not registered yet. The connection button 272 is a button for displaying a list of devices registered in the tenant. The storage button 273 is a button for displaying a list of storages 90 to store a wide-view image captured by the image capturing apparatus 10 associated with the virtual room. In response to the pressing of the connection button 272, the communication terminal 30A displays a virtual room association screen 280.

The communication terminal 30A transmits a virtual room ID to the information processing system 50 and acquires the name (or ID) of a device registered in the tenant in which the virtual room is generated and the name (or ID) of a device associated with the virtual room.

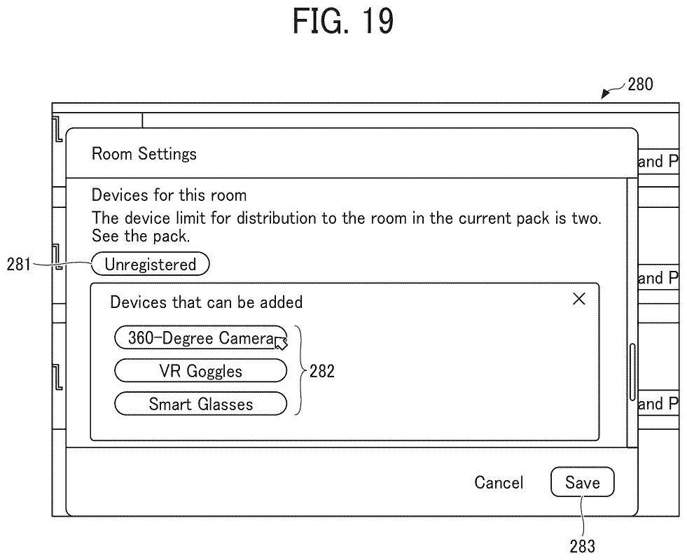

FIG. 19 illustrates an example of the virtual room association screen 280. The virtual room association screen 280 includes a name 281 of the image capturing apparatus 10 that is currently (or has already been) associated with the virtual room, a list of devices 282 that can be added, and a “Save” button 283. The user A selects a device to be associated with the virtual room from the list of devices 282 that can be added and then presses the “Save” button 283. As a result, the selected device is associated with the virtual room. That is, the corresponding image capturing apparatus ID is registered in the virtual room information storage unit 5002.

### Wide-View Image Transmission Start Process for Image Capturing Apparatus

In the way described above, a device such as the image capturing apparatus 10 is associated with the virtual room. The user A operates the device to start transmitting an image.

For the VR goggles 89 and the smart glasses 88, the user A operates the device main body to turn on or off the transmission of an image. This is because no application dedicated to the communication system 1 is currently operating on the VR goggles 89 or the smart glasses 88. If an application dedicated to the communication system 1 operates on the VR goggles 89 and the smart glasses 88, the user A can also remotely turn on or off the transmission of an image.

For the image capturing apparatus 10, when the application is enabled, the user A can turn on or off the transmission of a wide-view image from the menu of the application after entering the virtual room.

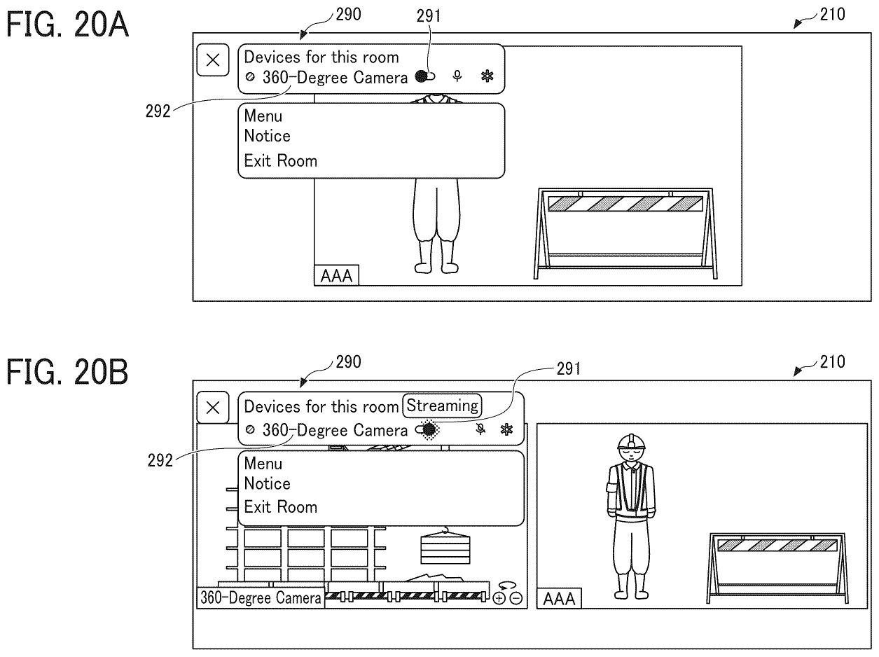

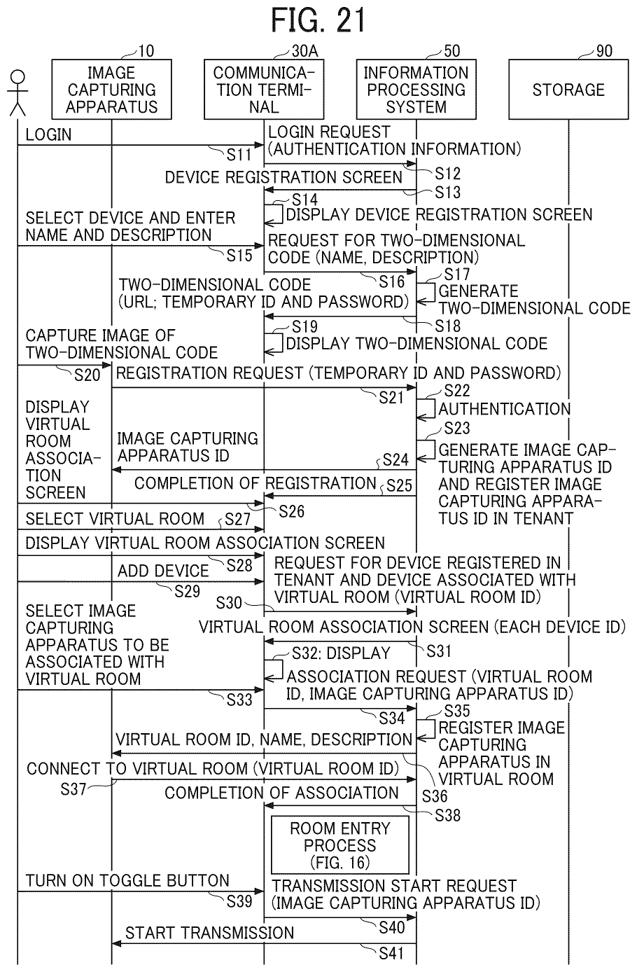

FIGS. 20A and 20B illustrate examples of a wide-view image transmission start/stop dialog 290 displayed on the communication terminal 30A. The wide-view image transmission start/stop dialog 290 is displayed as a pop-up on an image viewing screen 210. In the illustrated example, the user A has operated the communication terminal 30A and entered a virtual room associated with the image capturing apparatus 10. The wide-view image transmission start/stop dialog 290 displays a name 292 of the image capturing apparatus 10 associated with the virtual room. A toggle button 291 is displayed near the name 292. In one example, the user A operates the toggle button 291 to turn on or off the transmission of the wide-view image captured by the image capturing apparatus 10. Turning on or off the transmission of the wide-view image using a toggle button is merely an example, and any other method based on user operation input may be used. For example, a radio button or a predetermined icon may be selected, or a menu operation may be performed. Alternatively, the transmission of the wide-view image may be started automatically, without using a user operation, after the image capturing apparatus 10 enters the room. In another example, a predetermined condition such as the date and time, the number of users who have entered the room, or the participation of a specific user is determined in advance, and the transmission of the wide-view image is started based on a determination that the predetermined condition is satisfied.

The communication terminal 30A transmits the state of the toggle button 291 to the information processing system 50. The information processing system 50 transmits a transmission start request or a transmission stop request corresponding to the state of the toggle button 291 to the image capturing apparatus 10.

FIG. 20A illustrates an off state of the toggle button 291. In FIG. 20A, thus, the wide-view image is not displayed. By contrast, the image having a normal angle of view captured by the image capturing apparatus 9 of the communication terminal 30A is displayed in the image viewing screen 210 in FIG. 20A since the image having a normal angle of view has already been shared at the time of entry of the communication terminal 30A into the virtual room.

FIG. 20B illustrates an on state of the toggle button 291. In response to turning on of the toggle button 291, the information processing system 50 transmits a transmission start request to the image capturing apparatus 10. Accordingly, the image capturing apparatus 10 starts transmitting the wide-view image. Since two images are shared in one virtual room, the image viewing screen 210 is divided into two areas.

### Procedure for Registering Image Capturing Apparatus in Virtual Room

Next, a procedure for registering the image capturing apparatus 10 in the virtual room illustrated in the screen transitions will be described with reference to FIG. 21. FIG. 21 is a sequence diagram illustrating an example of a procedure in which the user A registers the image capturing apparatus 10 in the virtual room.
S11: First, the user A connects the communication terminal 30A to the information processing system 50 and enters authentication information (such as a user ID and a password) to make a login request to the tenant to which the user A belongs. The acceptance unit 32 of the communication terminal 30A accepts the operation.
S12: The communication unit 31 of the communication terminal 30A designates the authentication information and transmits the login request to the information processing system 50. In the information processing system 50, the communication unit 51 receives the login request, and the authentication unit 55 performs authentication. It is assumed that the authentication has been successful.
S13: In the information processing system 50, the screen generation unit 52 generates a device registration screen in response to the user operation, and the communication unit 51 transmits screen information of the device registration screen to the communication terminal 30A.
S14: The communication terminal 30A displays the device registration screen, based on the received screen information. More specifically: In the communication terminal 30A, the communication unit 31 receives the screen information of the device registration screen, and the display control unit 33 displays the device registration screen.
S15: The user A selects the type of the device (in the illustrated example, the image capturing apparatus 10). Then, the user A enters the name and description of the image capturing apparatus 10. The acceptance unit 32 receives the entered information.
S16: The communication unit 31 of the communication terminal 30A designates the name and description entered by the user A and transmits a request for a two-dimensional code to the information processing system 50.
S17: The communication unit 51 of the information processing system 50 receives the request for a two-dimensional code. The communication group management unit 56 generates a URL (connection destination for registration) in association with the name and the description, and generates a two-dimensional code including the URL, a temporary ID, and a password.
S18: The communication unit 51 of the information processing system 50 transmits the two-dimensional code to the communication terminal 30A.
S19: In the communication terminal 30A, the communication unit 31 receives the two-dimensional code, and the display control unit 33 displays the two-dimensional code.
S20: The user A operates the image capturing apparatus 10 to be associated with the virtual room to capture an image of the two-dimensional code. The acceptance unit 12 of the image capturing apparatus 10 accepts the operation.
S21: In the image capturing apparatus 10, the imaging processing unit 13 performs an operation for capturing an image including the two-dimensional code to generate image data, and the analysis unit 14 analyzes the image data to extract the URL, the temporary ID, and the password. Accordingly, the registration request unit 15 connects to the URL via the connection unit 16, designates the temporary ID and the password, and transmits a request for registering the image capturing apparatus 10 to the information processing system 50.
S22: In the information processing system 50, the communication unit 51 receives the temporary ID and the password, and the authentication unit 55 determines whether the received temporary ID and password match the temporary ID and password associated with the connected URL. It is assumed that a match has been found.
S23: Since a request for registering the image capturing apparatus 10 has been made, the communication group management unit 56 of the information processing system 50 generates an image capturing apparatus ID and registers the image capturing apparatus ID in the tenant to which the user A has logged in. The image capturing apparatus ID is associated with a name and a description.
S24: The communication unit 51 of the information processing system 50 transmits the image capturing apparatus ID to the image capturing apparatus 10. The connection unit 16 of the image capturing apparatus 10 receives the image capturing apparatus ID and stores the image capturing apparatus ID in the storage unit 1000.
S25: The communication terminal 30A is notified of the completion of the registration, and, accordingly, the user A starts associating the image capturing apparatus 10 with the virtual room.
S26: The user A displays the virtual room association screen 260 on the communication terminal 30A.
S27: The communication terminal 30A selects a virtual room with which the image capturing apparatus 10 registered in the tenant is to be associated. The acceptance unit 32 of the communication terminal 30A accepts the selection of the virtual room.
S28: The user A displays the virtual room association screen 270 on the communication terminal 30A.
S29: The user A performs an operation for pressing an “Add Device” button. The acceptance unit 32 of the communication terminal 30A accepts the pressing of the “Add Device” button.
S30: The communication unit 31 of the communication terminal 30A transmits to the information processing system 50 a request for devices registered in the tenant and devices associated with the virtual room ID selected in step S29.
S31: In the information processing system 50, the communication unit 51 receives the request for the devices registered in the tenant and the devices associated with the virtual room ID, and the screen generation unit 52 generates the virtual room association screen 280 including the device IDs of the devices registered in the tenant and the devices associated with the virtual room ID. The communication unit 51 of the information processing system 50 transmits screen information of the virtual room association screen 280 to the communication terminal 30A.
S32: In the communication terminal 30A, the communication unit 31 receives the screen information of the virtual room association screen 280, and the display control unit 33 displays the virtual room association screen 280.
S33: The user A selects the image capturing apparatus 10 to be associated with the virtual room. The acceptance unit 32 of the communication terminal 30A accepts the selection of the image capturing apparatus 10, and the image capturing apparatus ID is identified.
S34: The communication unit 31 of the communication terminal 30A designates the virtual room ID selected in step S27 and the image capturing apparatus ID selected in step S33, and transmits an association request to the information processing system 50.
S35: In the information processing system 50, the communication unit 51 receives the association request, and the communication group management unit 56 registers the image capturing apparatus 10 in the virtual room. That is, the communication group management unit 56 registers the image capturing apparatus ID in the virtual room information storage unit 5002.
S36: Since the image capturing apparatus ID is associated with the virtual room, the communication unit 51 of the information processing system 50 transmits the virtual room ID, the name, and the description to the image capturing apparatus 10. The information processing system 50 may transmit the virtual room ID, the name, and the description to the image capturing apparatus 10 by using a push notification or by using polling, which is performed by the image capturing apparatus 10. The connection unit 16 of the image capturing apparatus 10 receives the virtual room ID, the name, and the description and stores the virtual room ID, the name, and the description in the storage unit 1000. Accordingly, the image capturing apparatus 10 can attach, for example, the image capturing apparatus ID, the virtual room ID, the name, and the description to a wide-view image to be transmitted.
S37: The image capturing apparatus 10 connects to a virtual room identified by the virtual room ID in the information processing system 50.
S38: The communication terminal 30A is notified of the completion of the association.
S39: The user A turns on the toggle button 291 for the image capturing apparatus 10 associated with the virtual room on the image viewing screen 210. The acceptance unit 32 of the communication terminal 30A accepts the turn-on operation.
S40: The communication unit 31 of the communication terminal 30A designates the image capturing apparatus ID and transmits, to the information processing system 50, a request for starting transmission of the wide-view image. The user A may directly operate a button of the image capturing apparatus 10 to start transmission of the wide-view image. In response to an operation performed by the user A, the communication unit 31 of the communication terminal 30A may transmit a transmission stop request to the information processing system 50.
S41: The communication unit 51 of the information processing system 50 receives the transmission start request and requests the image capturing apparatus 10 identified by the image capturing apparatus ID to start transmission. The information processing system 50 may use a push notification or use polling, which is performed by the image capturing apparatus 10. In the image capturing apparatus 10, the connection unit 16 receives the transmission start request, and the imaging processing unit 13 starts capturing a wide-view image. The image transmission control unit 18 repeatedly transmits the wide-view image at a determined frame rate (expressed in FPS) or a frame rate (expressed in FPS) corresponding to a bandwidth via the connection unit 16. As a result, the communication terminal 30 that has entered the virtual room can display the state of the site A on the image viewing screen 210 in real time.

### Distribution of Wide-View Image and Others

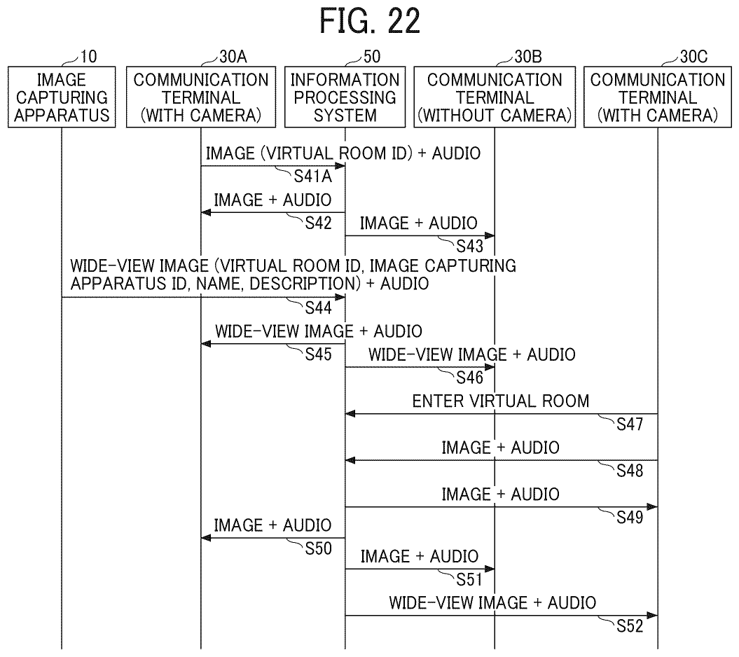

A process for sharing a wide-view image and an image having a normal angle of view will be described with reference to FIG. 22. FIG. 22 is a sequence diagram illustrating an example of a process for sharing a wide-view image. In FIG. 22, the communication terminals 30A and 30B have already entered the virtual room. The communication terminal 30A includes the image capturing apparatus 9 having a normal angle of view, and an image captured by the image capturing apparatus 9 is shared with the communication terminal 30B. An image captured by the smart glasses 88 associated with the virtual room, instead of the image capturing apparatus 9 of the communication terminal 30A, may be shared.
S41A: In the communication terminal 30A, the imaging unit 34 repeatedly captures an image to obtain captured images, and the communication unit 31 designates the virtual room ID of the virtual room that the communication terminal 30A is in and repeatedly transmits the images and audio to the information processing system 50.
S42 and S43: In the information processing system 50, in response to the communication unit 51 receiving the images and the audio, the image dis77tribution unit 54 acquires the IP addresses of the communication terminals 30A and 30B, which are in the virtual room, from the virtual room information storage unit 5002, and transmits the images and the audio via the communication unit 51.
S44: In the image capturing apparatus 10, in response to a transmission start request made by turning on the toggle button 291, the imaging processing unit 13 repeatedly captures a wide-view image to obtain captured wide-view images, and the image transmission control unit 18 designates the virtual room ID, the image capturing apparatus ID, the name, and the description and repeatedly transmits the wide-view images and audio to the information processing system 50 via the connection unit 16.
S45 and S46: In the information processing system 50, in response to the communication unit 51 receiving the wide-view images and the audio, the image distribution unit 54 acquires the IP addresses of the communication terminals 30A and 30B, which are in the virtual room, from the virtual room information storage unit 5002, and transmits the wide-view images and the audio via the communication unit 51.
S47: The communication terminal 30C including the image capturing apparatus 9 newly enters the virtual room.
S48: The communication unit 31 of the communication terminal 30C transmits an image having a normal angle of view and audio to the information processing system 50.
S49 to S51: In the information processing system 50, the communication unit 51 receives the image having a normal angle of view and the audio from the communication terminal 30C, and the image distribution unit 54 acquires the IP addresses of the communication terminals 30A to 30C, which are in the virtual room, from the virtual room information storage unit 5002, and transmits the image having a normal angle of view and the audio.
S52: The communication unit 51 of the information processing system 50 also transmits the wide-view images and the audio to the communication terminal 30C, which is in the same virtual room.

As described above, the users A, B, and C, who are in the same virtual room, can share the wide-view images captured by the image capturing apparatus 10 associated with the virtual room. The order of transmission of the images illustrated in FIG. 22 is an example. In another example, the wide-view images may be shared first, or the images having a normal angle of view may be shared first.

A supplementary description will be given of the smart glasses 88 and the VR goggles 89. The smart glasses 88 have a camera having a normal angle of view and a display function. The camera of the smart glasses 88 captures an image having a normal angle of view, and the captured image having a normal angle of view is distributed in a manner similar to that for the image capturing apparatuses 8 and 9. The display function of the smart glasses 88 is implemented by a flat screen, like that of an ordinary display. Thus, part of a wide-view image is displayed from a point of view designated by the user. The VR goggles 89 have a display function. The VR goggles 89 may also include a camera having a normal angle of view. The display function of the VR goggles 89 projects a wide-view image with a point of view determined by the orientation of the head of the user wearing the VR goggles 89. Thus, part of the wide-view image is displayed from a point of view corresponding to the orientation of the head of the user. While viewing a wide-view image with the smart glasses 88 or the VR goggles 89, the user can transmit, to the information processing system 50, an image capturing request that designates point-of-view information of the wide-view image being viewed.

Next, the viewing-state storage unit 5004 will be described hereinafter with reference to FIGS. 23A and 23B.

In the following description, it is assumed that the user A at the site A, the user B at the site B, the user C at the site C, and a user D at a site D have entered one virtual room. The site D has a configuration similar to that of the sites B and C. In the following description, by way of example, distribution image data is distributed to the communication terminals 30 placed at the respective sites. The distribution image data includes wide-view image data transmitted from the image capturing apparatus 10 placed at the site A, and normal-angle-of-view image data transmitted from a camera included in or from the image capturing apparatus 8 or 9 connected to the communication terminal 30 at each of the sites B, C, and D.

FIGS. 23A and 23B are diagrams illustrating an example of the viewing-state storage unit 5004. FIG. 23A is a diagram illustrating an example of site-of-interest information 5004a included in viewing-state information and indicating sites of interest, each being focused on by a respective one of the sites A to D.

The site-of-interest information 5004a is stored for each virtual room. The site-of-interest information 5004a includes items of information, namely, a virtual room ID, a timestamp, a site address of each site, and a site of interest for each site, in association with one another. The item “virtual room ID” contains a value representing identification information for identifying a virtual room. The item “timestamp” contains values each representing a time at which distribution image data is distributed.

The item “site address” contains values each representing information for specifying a respective one of the sites A to D. In the example illustrated in FIG. 23A, the item “site address” contains values each representing the IP address of the communication terminal 30 installed at a respective one of the sites A to D.

The item “site of interest” contains values each representing another site that is focused on by a site specified by the associated one of the values contained in the item “site address”.

FIG. 23B is a diagram illustrating an example of designated-point-of-view information 5004b for the respective sites, which is included in the viewing-state information. The designated-point-of-view information 5004b includes items of information, namely, a virtual room ID, a timestamp, and designated-point-of-view information of a wide-view image for each site, in association with one another.

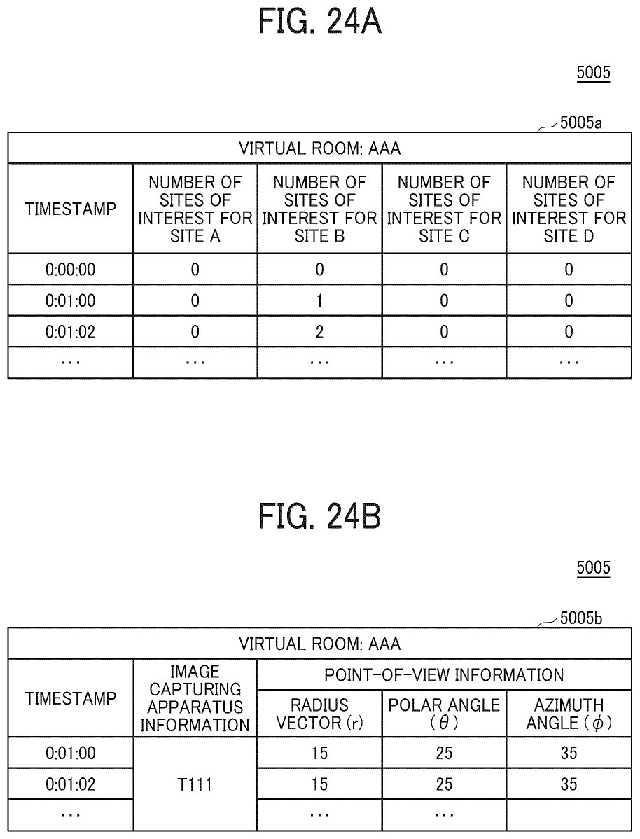

Next, the aggregate-result storage unit 5005 will be described with reference to FIGS. 24A and 24B. FIGS. 24A and 24B are diagrams illustrating an example of the aggregate-result storage unit 5005. FIG. 24A is a diagram illustrating an example of number-of-sites-of-interest information 5005a included in aggregate-result information.

The number-of-sites-of-interest information 5005a is stored for each virtual room. The number-of-sites-of-interest information 5005a includes items of information, namely, a virtual room ID, a timestamp, and the number of sites of interest for each site, in association with one another. The item “virtual room ID” contains a value representing identification information for identifying a virtual room. The item “timestamp” contains values each representing a time at which distribution image data is distributed.

The item “number of sites for site A” contains values each representing the number of sites focusing on the site A at a time indicated by the associated one of the values contained in the item “timestamp” among the sites at which users who have entered the virtual room identified by the virtual room ID are located. In other words, the item “number of sites for site A” indicates the number of communication terminals 30 on which the wide-view image captured at the site A is displayed in an enlarged manner among the communication terminals 30 whose IP addresses are associated with the virtual room ID. The item “number of sites for site B” contains values each representing the number of sites focusing on the site B at a time indicated by the associated one of the values contained in the item “timestamp” among the sites at which users who have entered the virtual room identified by the virtual room ID are located. In other words, the item “number of sites for site B” indicates the number of communication terminals 30 on which the normal-angle-of-view image captured at the site B is displayed in an enlarged manner among the communication terminals 30 whose IP addresses are associated with the virtual room ID.

The item “number of sites for site C” contains values each representing the number of sites focusing on the site C at a time indicated by the associated one of the values contained in the item “timestamp” among the sites at which users who have entered the virtual room identified by the virtual room ID are located. In other words, the item “number of sites for site C” indicates the number of communication terminals 30 on which the normal-angle-of-view image captured at the site C is displayed in an enlarged manner among the communication terminals 30 whose IP addresses are associated with the virtual room ID. The item “number of sites for site D” contains values each representing the number of sites focusing on the site D at a time indicated by the associated one of the values contained in the item “timestamp” among the sites at which users who have entered the virtual room identified by the virtual room ID are located. In other words, the item “number of sites for site D” indicates the number of communication terminals 30 on which the normal-angle-of-view image captured at the site D is displayed in an enlarged manner among the communication terminals 30 whose IP addresses are associated with the virtual room ID.

In the example illustrated in FIG. 24A, at the timestamp “0:01:00”, the number of sites focusing on the site B is one and the number of sites focusing on each of the sites A, C, and D is zero among the sites A to D. At the timestamp “0:01:02”, the number of sites focusing on the site B is two and the number of sites focusing on each of the sites A, C, and D is zero among the sites A to D.

Accordingly, in this case, the sites of highest interest at the timestamps “0:01:00” and “0:01:02” are both set to the site B. Information indicating the site of highest interest specified by the site-of-interest specifying unit 63 is stored in the aggregate-result storage unit 5005 as part of the aggregate-result information. If information indicating a site of highest interest is not stored in the aggregate-result storage unit 5005, processing of the site-of-interest specifying unit 63 is executed to reproduce distribution image data described below.

FIG. 24B is a diagram illustrating an example of point-of-view-of-highest-interest information 5005b included in the aggregate-result information. The point-of-view-of-highest-interest information includes items of information, namely, a virtual room ID, a timestamp, image capturing apparatus information, and point-of-view information, in association with one another.

The example illustrated in FIG. 24B indicates that the points of view of highest interest at the timestamps “0:01:00” and “0:01:02” are each represented by a radius vector of 15 (r), a polar angle of 25 (θ), and an azimuth angle of 35 (φ).

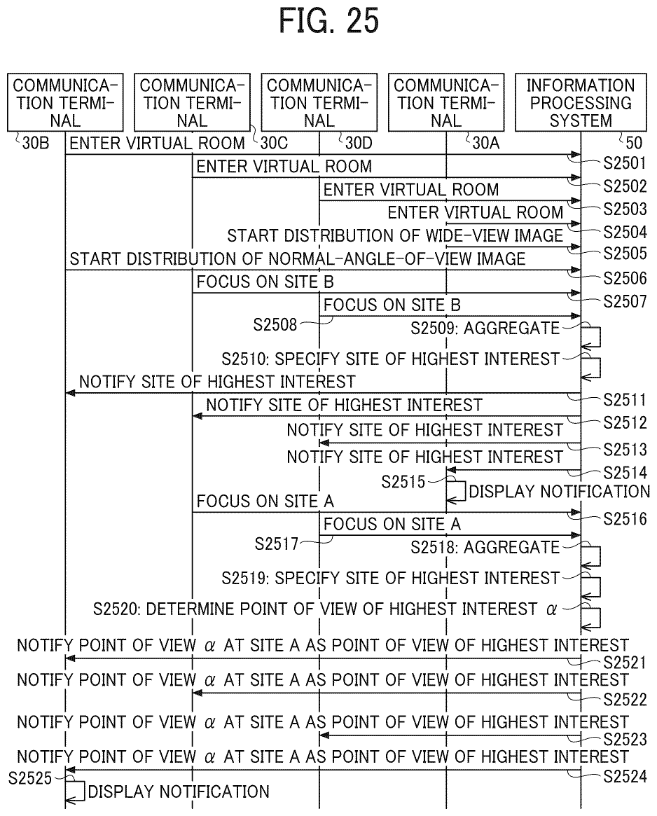

Next, an operation of the communication system 1 will be described with reference to FIG. 25. FIG. 25 is a sequence diagram illustrating an operation of the communication system 1. In FIG. 25, the processing of steps S2501 to S2515 represents operations performed in a case where the user A at the site A, the user B at the site B, the user C at the site C, and the user D at the site D enter one virtual room and the user C at the site C and the user D at the site D focus on the site B.

The communication terminals 30 at the sites A to D enter a virtual room associated with the communication terminals 30 in the information processing system 50 (steps S2501 to S2504).

Subsequently, the communication terminal 30A at the site A starts transmission of wide-view image data captured by the image capturing apparatus 10 placed at the site A to the information processing system 50 (step S2505). In other words, the information processing system 50 starts distribution of distribution image data including the wide-view image data captured by the image capturing apparatus 10 at the site A to the communication terminals 30 that are in the virtual room.

Subsequently, the communication terminal 30B at the site B starts transmission of normal-angle-of-view image data to the information processing system 50 (step S2506). In other words, the information processing system 50 starts distribution of distribution image data including the wide-view image data captured by the image capturing apparatus 10 and the normal-angle-of-view image data received from the communication terminal 30B to the communication terminals 30 that are in the virtual room.

In the communication system 1, in response to image data being transmitted from each site, the image data transmitted from each site is stored in association with the virtual room. Accordingly, in this case, the wide-view image data transmitted from the site A is stored in the information processing system 50 in association with the site A and the virtual room ID of the virtual room. Further, the normal-angle-of-view image data transmitted from the site B is stored in the information processing system 50 in association with the site B and the virtual room ID of the virtual room. Storing the image data for each site allows a user to perform operations on the wide-view image and the normal-angle-of-view image captured at the respective sites, such as changing points of view for the wide-view image and the normal-angle-of-view image and enlarging or reducing the sizes of the wide-view image and the normal-angle-of-view image, even when the user reviews the distribution image data.

Subsequently, the user C of the communication terminal 30C focuses on the site B (step S2507). Specifically, in response to an operation by the user C for enlarging the normal-angle-of-view image captured by the communication terminal 30B in the distribution image displayed on the communication terminal 30C, the communication terminal 30C transmits an instruction to the information processing system 50 to enlarge the normal-angle-of-view image captured at the site B. In the information processing system 50, in accordance with this operation, the site-of-interest information 5004a in the viewing-state storage unit 5004 is updated.

The user D of a communication terminal 30D also focuses on the site B (step S2508). Specifically, in response to an operation by the user D for enlarging the normal-angle-of-view image captured by the communication terminal 30B in the distribution image displayed on the communication terminal 30D, the communication terminal 30D transmits an instruction to the information processing system 50 to enlarge the normal-angle-of-view image captured at the site B. In the information processing system 50, in accordance with this operation, the site-of-interest information 5004a in the viewing-state storage unit 5004 is further updated.

Subsequently, the viewing-state aggregation unit 62 of the information processing system 50 aggregates the site-of-interest information 5004a stored in the viewing-state storage unit 5004 (step S2509). Subsequently, the site-of-interest specifying unit 63 of the information processing system 50 specifies a site of highest interest at this point in time (step S2510).

In the illustrated example, among the users at the sites A to D, the user C at the site C and the user D at the site D are focusing on the site B. Accordingly, the site-of-interest specifying unit 63 determines the site B as the site of highest interest.

Subsequently, the information processing system 50 notifies the communication terminals 30 at the sites A to D of the specified site of highest interest (steps S2511 to S2514). In other words, the information processing system 50 transmits information indicating the site of highest interest specified by the site-of-interest specifying unit 63 to the communication terminal 30 placed at each of the sites A to D.

In the example illustrated in FIG. 25, the site of highest interest is notified to all the communication terminals 30 used by the users who are in the same virtual room. However, this does not imply any limitation. The notification of the site of highest interest may be transmitted only to a communication terminal 30 at a site not focusing on the site of highest interest.

The communication terminal 30A displays information indicating the site of highest interest (step S2515). In the present embodiment, displaying the information indicating the site of highest interest on the communication terminal 30A allows the user A of the communication terminal 30A, who is not focusing on the site B, to recognize that the site B is specified as the site of highest interest.

In the example illustrated in FIG. 25, the information indicating the site of highest interest is displayed on the communication terminal 30A, thus allowing the site of highest interest to be recognized by a user who is at a site other than the site of highest interest and is not focusing on the site of highest interest among users who are in the same virtual room. The present embodiment is not limited to this example, and the information indicating the site of highest interest may be displayed on all the communication terminals 30 used by the users who are in the same virtual room. In the present embodiment, the information indicating the site of highest interest may be displayed on all the communication terminals 30 placed at sites other than the site specified as the site of highest interest.

Next, a case where the site A at which the wide-view image is captured is focused on will be described. In FIG. 25, the processing of steps S2516 to S2525 represents operations performed in a case where the user C at the site C and the user D at the site D focus on the site A.

The user C of the communication terminal 30C focuses on the site A (step S2516). Specifically, in response to an operation by the user C for enlarging the wide-view image captured at the site A in the distribution image displayed on the communication terminal 30C, the communication terminal 30C transmits an instruction to the information processing system 50 to enlarge the wide-view image. In the information processing system 50, in accordance with this operation, the site-of-interest information 5004a in the viewing-state storage unit 5004 is further updated.

The user D of the communication terminal 30D focuses on the site A (step S2517). Specifically, in response to an operation by the user D for enlarging the wide-view image captured at the site A in the distribution image displayed on the communication terminal 30D, the communication terminal 30D transmits an instruction to the information processing system 50 to enlarge the wide-view image. In the information processing system 50, in accordance with this operation, the site-of-interest information 5004a in the viewing-state storage unit 5004 is further updated.

Subsequently, the viewing-state aggregation unit 62 of the information processing system 50 aggregates the site-of-interest information 5004a stored in the viewing-state storage unit 5004 (step S2518). Subsequently, the site-of-interest specifying unit 63 of the information processing system 50 specifies a site of highest interest at this point in time (step S2519). At the site A specified as the site of highest interest, the wide-view image has been captured. Accordingly, the point-of-view-of-interest determination unit 64 of the information processing system 50 determines a point of view of highest interest at this point in time (step S2520).

In the example illustrated in FIG. 25, when an image captured at the site of highest interest is a wide-view image, a point of view of highest interest is determined. However, this does not imply any limitation. Even when an image captured at the site of highest interest is a normal-angle-of-view image, the information processing system 50 can determine a point of view of highest interest independently of the site of highest interest and notify the point of view of highest interest to the communication terminals 30 at the respective sites.

Subsequently, the information processing system 50 notifies the communication terminals 30 at the sites A to D of the specified site of highest interest and the determined point of view of highest interest (steps S2521 to S2524). In other words, the information processing system 50 transmits, to the communication terminal 30 placed at each of the sites A to D, information indicating the site of highest interest specified by the site-of-interest specifying unit 63 and point-of-view information indicating the point of view of highest interest determined by the point-of-view-of-interest determination unit 64.

In the example illustrated in FIG. 25, a site of highest interest and a point of view of highest interest are notified to all the communication terminals 30 used by the users who are in the same virtual room. However, this does not imply any limitation. The notification of the site of highest interest and the point of view of highest interest may be transmitted only to a communication terminal 30 at a site not focusing on the site of highest interest.

Subsequently, the communication terminal 30B displays the information indicating the site of highest interest and the point-of-view information indicating the point of view of highest interest (step S2525).

In the present embodiment, displaying the information indicating the site of highest interest and the point-of-view information indicating the point of view of highest interest on the communication terminal 30B allows the user B of the communication terminal 30B, who is not focusing on the site A, to recognize that the users at the other sites are focusing on the point of view of highest interest in the wide-view image captured at the site A.

In the example illustrated in FIG. 25, information indicating the site of highest interest and the point-of-view information indicating the point of view of highest interest are displayed on the communication terminal 30B, thus allowing the site of highest interest and the point of view of highest interest to be recognized by a user who is at a site other than the site of highest interest and is not focusing on the site of highest interest among users who are in the same virtual room. The present embodiment is not limited to this example, and the information indicating the site of highest interest and the point-of-view information indicating the point of view of highest interest may be displayed on all the communication terminals 30 used by the users who are in the same virtual room. In the present embodiment, the information indicating the site of highest interest and the point-of-view information indicating the point of view of highest interest may be displayed on all the communication terminals 30 placed at sites other than the site specified as the site of highest interest.

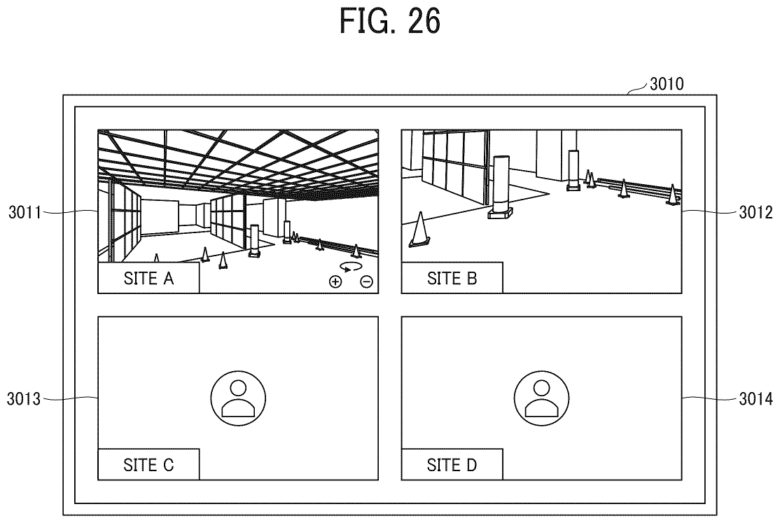

The following describes examples of screens displayed on the communication terminal 30 with reference to FIGS. 26 to 28. FIG. 26 is a first diagram illustrating an example of a screen displayed on the communication terminal 30.

A screen 3010 illustrated in FIG. 26 is an example of a screen displayed on the communication terminal 30 at each site when the users at the sites A to D are in the same virtual room. For example, the screen 3010 is displayed on the communication terminals 30 at the sites A to D during a period of time between the processing of step S2506 and the processing of step S2507 in FIG. 25.

The screen 3010 includes display areas 3011, 3012, 3013, and 3014. On the screen 3010, the display areas 3011, 3012, 3013, and 3014 have the same size.

The display area 3011 displays the wide-view image captured at the site A, and the display area 3012 displays the normal-angle-of-view image captured at the site B. The display area 3013 displays an image for the site C. The display area 3014 displays an image for the site D. In response to starting capture of a normal-angle-of-view image at the site C, the normal-angle-of-view image captured at the site C is displayed in the display area 3013. In response to starting capture of a normal-angle-of-view image at the site D, the normal-angle-of-view image captured at the site D is displayed in the display area 3014.

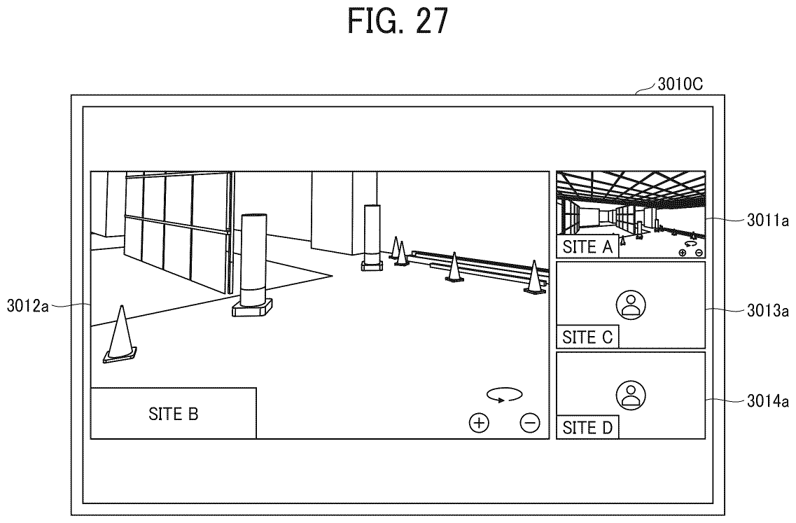

FIG. 27 is a second diagram illustrating an example of a screen displayed on the communication terminal 30. A screen 3010C illustrated in FIG. 27 is an example of a screen in a case where an operation for focusing on the normal-angle-of-view image captured at the site B is performed on the screen 3010 illustrated in FIG. 26 displayed on the communication terminal 30C. The operation for focusing on the normal-angle-of-view image captured at the site B is, for example, a selection operation for selecting the display area 3012 on the screen 3010. In the present embodiment, in response to the selection operation, the display area 3012 is displayed in an enlarged manner, or only the display area 3012 is displayed on the screen 3010.

The screen 3010C is displayed on the communication terminal 30C, for example, after the processing of step S2507 in FIG. 25. The screen 3010C includes display areas 3011a, 3012a, 3013a, and 3014a. The display area 3011a displays the wide-view image captured at the site A, and the display area 3012a displays the normal-angle-of-view image captured at the site B. When a normal-angle-of-view image is captured at the site C, the captured normal-angle-of-view image is displayed in the display area 3013a. When a normal-angle-of-view image is captured at the site D, the captured normal-angle-of-view image is displayed in the display area 3014a.

On the screen 3010C, the display area 3012a has the largest size, and the display areas 3011a, 3013a, and 3014a have smaller sizes than the display area 3012a. Accordingly, the screen 3010C indicates that the site B at which the normal-angle-of-view image displayed in the display area 3012a is captured is being focused on.

In the example illustrated in FIG. 27, the display area that displays an image captured at the site being focused on is enlarged. However, this does not imply any limitation. For example, the screen 3010 illustrated in FIG. 26 is displayed on the communication terminal 30C at the site C, and an operation for focusing on the normal-angle-of-view image captured at the site B is performed on the screen 3010. In this case, the communication terminal 30C does not enlarge the display area 3012 in which the normal-angle-of-view image captured at the site B is displayed, but may display the display area 3012 in an emphasized manner. Specifically, for example, the edge of an image displayed in the display area 3012 may be displayed in a different color.

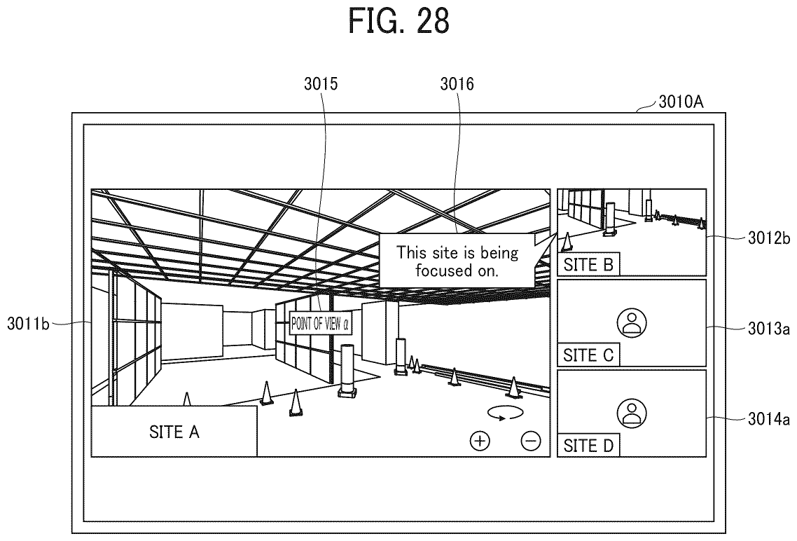

FIG. 28 is a third diagram illustrating an example of a screen displayed on the communication terminal 30. A screen 3010A illustrated in FIG. 28 is an example of a screen displayed on the communication terminal 30A when the site B is specified as the site of highest interest. The screen 3010A is, for example, an example of a screen displayed on the communication terminal 30A in step S2515 in FIG. 25.

The screen 3010A includes display areas 3011b, 3012b, 3013a, and 3014a. The display area 3011b displays the wide-view image captured at the site A, and has a larger size than the display areas 3012b, 3013a, and 3014a. Accordingly, the screen 3010A indicates that, at the site A, the site B is not being focused on but the wide-view image captured at the site A is being focused on.

The display area 3011b also displays an image 3015. The image 3015 indicates a point of view designated in the wide-view image at the site A.

The display area 3012b displays the normal-angle-of-view image captured at the site B, which is specified as the site of highest interest. In the present embodiment, an image 3016 that designates the display area 3012b is displayed. The image 3016 may be an image including a message such as “This site is being focused on”.

As described above, the screen 3010A displays the image 3015 indicating a point of view in the wide-view image and the image 3016 indicating the site of highest interest. Accordingly, the present embodiment allows the user A of the communication terminal 30A to recognize the point of view being focused on by the user A in the wide-view image. The present embodiment also allows the user A of the communication terminal 30A to recognize that other users who are in the same virtual room are focusing on an image of a site different from the site being focused on by the user A.

In the example illustrated in FIG. 28, the image 3016 is displayed to notify the user A of the communication terminal 30A of an image of the site of highest interest. However, this does not imply any limitation. The screen 3010A may be displayed in any manner as long as it is possible to recognize that the normal-angle-of-view image captured at the site B is an image having the highest level of interest.

For example, on the screen 3010A, when the site B is specified as the site of highest interest, the display area 3012b may be automatically enlarged whereas the display area 3011b is reduced to be identical in size to the display areas 3013a and 3014a. This display allows the user A of the communication terminal 30A to recognize that other users are focusing on the normal-angle-of-view image captured at the site B without the display of the image 3016.

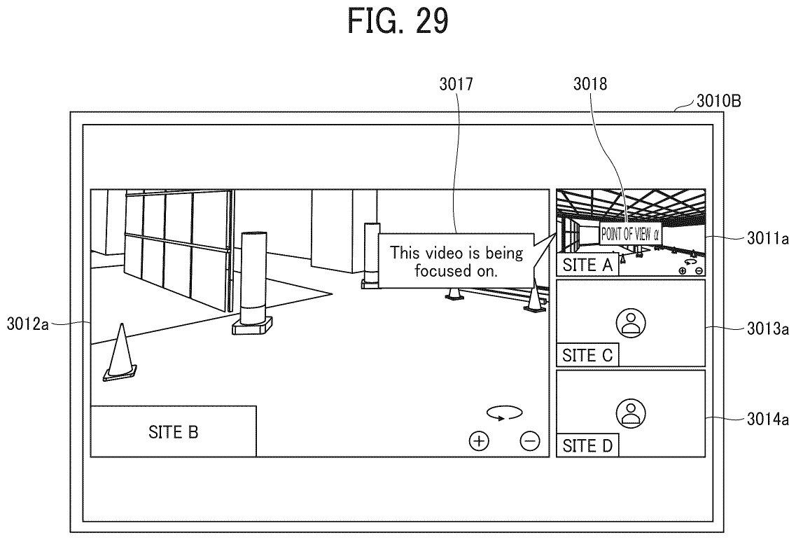

FIG. 29 is a fourth diagram illustrating an example of a screen displayed on the communication terminal 30. A screen 3010B illustrated in FIG. 29 is an example of a screen displayed on the communication terminal 30B when the site A is specified as the site of highest interest. The screen 3010B is, for example, an example of a screen displayed on the communication terminal 30B in step S2525 in FIG. 25.

The screen 3010B includes display areas 3011a, 3012a, 3013a, and 3014a. On the screen 3010B, the display area 3012a has the largest size, and the display areas 3011a, 3013a, and 3014a have smaller sizes than the display area 3012a. Accordingly, the screen 3010B indicates that, at the site B, the wide-view image captured at the site A is not being focused on, but the normal-angle-of-view image captured at the site B is being focused on.

The screen 3010B further displays images 3017 and 3018. The image 3017 includes a message indicating that the site A at which the wide-view image displayed in the display area 3011a is captured is the site of highest interest. The image 3018 indicates the point of view of highest interest in the wide-view image captured at the site A, which is the site of highest interest.

In the present embodiment, accordingly, displaying the images 3017 and 3018 allows the user B to recognize the site and the point of view being focused on by other users who are in the same virtual room even when the site of highest interest is not being focused on by the user B at the site B.

Next, an operation of the communication system 1 in a case where the distribution image data is reviewed after distribution at each communication terminal 30 will be described. In the following description, reviewing the distribution image data after distribution at the communication terminal 30 may be referred to as reproducing the distribution image data.

The information processing system 50 allows the communication terminal 30 to reproduce the distribution image data in the following two methods. In a first method, the information processing system 50 transmits distribution image data stored in the information processing system 50 and viewing-state information associated with the distribution image data to the communication terminal 30, and the communication terminal 30 generates, based on the distribution image data and the viewing-state information, reproduction image data in which viewing states of the communication terminals 30 at the respective sites are reflected, and reproduces the reproduction image data.

In a second method, the information processing system 50 generates, based on distribution image data and viewing-state information stored in the information processing system 50, reproduction image data in which viewing states of the communication terminals 30 at the respective sites are reflected, and transmits the generated reproduction image data to the communication terminal 30.

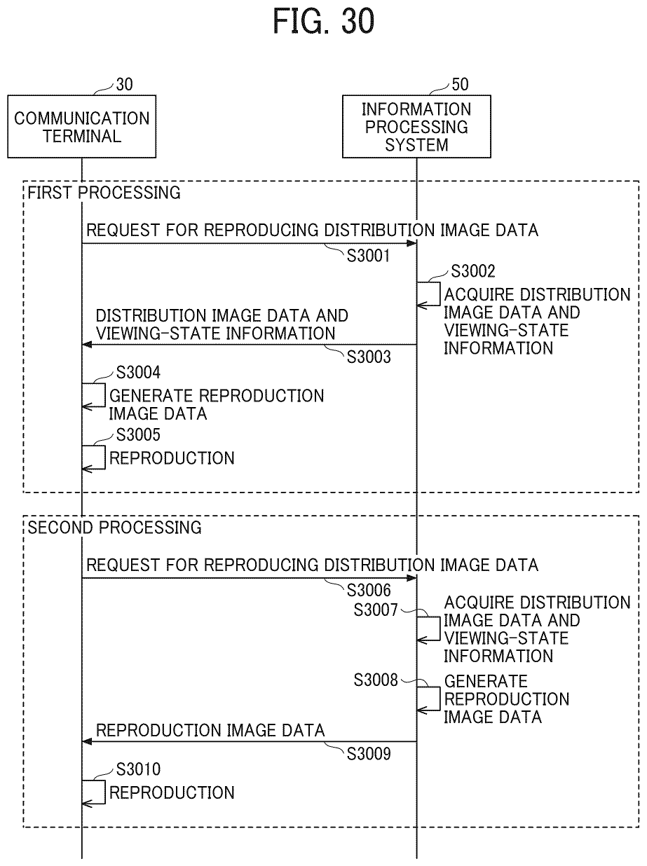

An operation of the communication system 1 in a case where the distribution image data is reviewed after distribution at the communication terminal 30 will be described with reference to FIG. 30. FIG. 30 is another sequence diagram illustrating an operation of the communication system 1.

First, operations in a case where the distribution image data is reviewed at the communication terminal 30 by using the first method described above will be described. In FIG. 30, the processing of steps S3001 to S3005 represents processing (first processing) using the first method described above.

In the communication system 1, the communication terminal 30 transmits a reproduction request for reproducing stored distribution image data to the information processing system 50 (step S3001). The reproduction request includes, for example, the IP address of the communication terminal 30 and the virtual room ID of the virtual room that the communication terminal 30 has entered.

In response to the reproduction request, the information processing system 50 specifies the virtual room that the communication terminal 30 has entered, and acquires distribution image data and viewing-state information that are associated with the virtual room (step S3002). Subsequently, the information processing system 50 transmits the acquired distribution image data and viewing-state information to the communication terminal 30 (step S3003).

At this time, the information processing system 50 may transmit aggregate-result information stored in the aggregate-result storage unit 5005, instead of the viewing-state information, to the communication terminal 30, or may transmit both the viewing-state information and the aggregate-result information to the communication terminal 30.

In response to the communication terminal 30 acquiring the distribution image data and the viewing-state information from the information processing system 50, the display control unit 33 reflects the viewing states in the distribution image data to generate reproduction image data (step S3004). The generated reproduction image data indicates a reproduction image including, as illustrated in FIGS. 26 to 29, display areas that display images of the respective sites. The reproduction image data generated by reflecting the viewing states in the distribution image data is image data generated based on the distribution image data and the viewing-state information.

Further, the communication terminal 30 designates, based on the distribution image data and the viewing-state information, a site of highest interest for each timestamp and generates reproduction image data including information indicating the site of highest interest. When the site of highest interest is the site A from which the wide-view image data is transmitted, the communication terminal 30 generates reproduction image data including the point of view of highest interest.

Subsequently, the display control unit 33 of the communication terminal 30 displays the generated reproduction image data (step S3005). In other words, the display control unit 33 of the communication terminal 30 displays image data in which the viewing states at the respective sites are reflected in the distribution image data.

In the present embodiment, as described above, the viewing-state information indicating viewing states of the distribution image data at the respective sites is transmitted to the communication terminal 30 together with the distribution image data distributed to the respective sites. Accordingly, the present embodiment enables the communication terminal 30 to display the reproduction image data in which viewing states of users of the communication terminals 30 at the respective sites at the time of distribution of the distribution image data are reflected.

Next, operations in a case where the distribution image data is reproduced on the communication terminal 30 by using the second method described above will be described. In FIG. 30, the processing of steps S3006 to S3010 represents processing (second processing) using the second method described above.

The communication terminal 30 transmits a reproduction request for reproducing the distribution image data to the information processing system 50 (step S3006). The reproduction request includes, for example, the IP address of the communication terminal 30 and the virtual room ID of the virtual room that the communication terminal 30 has entered.

In response to the reproduction request, the information processing system 50 specifies the virtual room that the communication terminal 30 has entered, and acquires the distribution image data and viewing-state information of the communication terminal 30 that are associated with the virtual room (step S3007). Subsequently, the screen generation unit 52 of the information processing system 50 generates, based on the distribution image data and the viewing-state information, reproduction image data in which the viewing-state information is reflected (step S3008).

The generated reproduction image data indicates a reproduction image including, as illustrated in FIGS. 26 to 29, display areas that display images captured at the respective sites, as in step S3004.

Further, the information processing system 50 designates, based on the distribution image data transmitted to the respective sites and the viewing-state information for each site, a site of highest interest for each timestamp and generates reproduction image data including information indicating the site of highest interest. When the site of highest interest is the site A from which the wide-view image data is transmitted, the information processing system 50 generates reproduction image data including the point of view of highest interest.

Subsequently, the information processing system 50 transmits the generated reproduction image data to the communication terminal 30 (step S3009). In response to receipt of the reproduction image data from the information processing system 50, the communication terminal 30 reproduces the reproduction image data (step S3010). The reproduction image data is an example of a viewing result.

In FIG. 30, in response to a reproduction request for reproducing the distribution image data, reproduction image data is generated based on the distribution image data and the viewing-state information such that viewing states at the respective sites during distribution of the distribution image data are reflected in the reproduction image data, and the reproduction image data is reproduced, but this is not limiting. In the present embodiment, in response to an acquisition request for acquiring viewing states from the communication terminal 30, the viewing-state information indicating viewing states at the respective sites may be displayed on the communication terminal 30. For example, information as illustrated in FIGS. 23A and 23B and FIGS. 24A and 24B is displayed on the communication terminal 30. The viewing-state information is an example of a viewing result.

Accordingly, the communication terminal 30 can recognize a viewing state of the distributed image data.

As described above, in the present embodiment, the viewing-state information indicating viewing states at the respective sites while the distribution image data is being distributed to the communication terminals 30 at the respective sites is stored in association with the distribution image data. In the present embodiment, when the distribution image data is reproduced after distribution, the distribution image data and the viewing-state information are used to generate reproduction image data in which viewing states at the respective sites during distribution of the distribution image data are reflected.

Accordingly, the present embodiment enables the communication terminal 30 requesting reproduction of the distribution image data to display reproduction image data in which viewing states at the respective sites during distribution of the distribution image data are reflected. For example, when the distribution image data is to be reproduced on the communication terminal 30A at the site A, reproduction image data reflecting viewing states at sites other than the site A is displayed on the communication terminal 30A, based on the viewing-state information. When the distribution image data is to be reproduced on the communication terminal 30B at the site B, reproduction image data reflecting viewing states at sites other than the site B is displayed on the communication terminal 30B, based on the viewing-state information.

Therefore, the present embodiment allows a user who is viewing the reproduction image data on the communication terminal 30 at a certain site to recognize a site of highest interest and a point of view of highest interest in a manner similar to that during the distribution of the distribution image data. In other words, the present embodiment allows a user to identify at which site an image was captured and during which time period the image was focused on by other users when the user reviews the distribution image data later. In the present embodiment, furthermore, when the site being focused on is a site at which wide-view image data is captured, a user who reviews the distribution image data can identify which point of view in the wide-view image was focused on by other users.

In the present embodiment, the image capturing apparatus 10 that captures a wide-view image is provided at the site A. However, this does not imply any limitation. In another example, the communication system 1 does not include the image capturing apparatus 10 that captures a wide-view image. In a case where the communication system 1 does not include the image capturing apparatus 10, an image captured at the site A is an image captured by the communication terminal 30A or an image capturing apparatus communicable with the communication terminal 30A and configured to capture a normal-angle-of-view image.

The communication system 1 may also be applied to telemedicine. The following describes a case where the communication system 1 is applied to telemedicine.

### Application Example of Communication System in Telemedicine

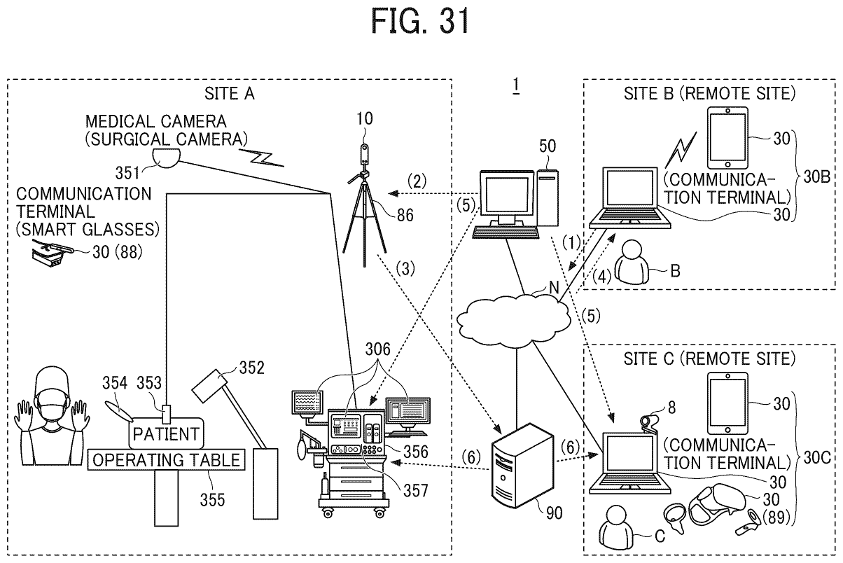

FIG. 31 is a diagram illustrating an example of remote communication using the communication system 1 in telemedicine. In the description of FIG. 31, differences from FIG. 1 will be described. In FIG. 31, the site A is an operating room. The processing steps (1) to (6) in FIG. 31 may be similar to those in FIG. 1.

In FIG. 31, a patient is placed on an operating table 355 and is subjected to surgery by a medical professional such as a surgeon. The medical professional (corresponding to the user) operates on the patient with various surgical tools 354 such as forceps and a scalpel. The medical professional may wear the smart glasses 88 and transmit an image of the surgical field for surgery performed by the medical professional to the communication network N. Various cameras are placed in the operating room as image capturing apparatuses similar to the image capturing apparatus 10. The cameras include a surgical camera 351, a surgical field camera 352, and an endoscope 353. The image capturing apparatuses have a function of capturing an image for generating a wide-view image. All of the image capturing apparatuses in the operating room and the smart glasses 88 can be associated with a virtual room.

A main unit 356 is installed in the operating room. The main unit 356 monitors, for example, the vitals of a patient, and the operating state of medical devices. The main unit 356 corresponds to the communication terminal 30. The communication terminal 30 (i.e., the main unit 356) in the operating room may have a function of receiving video from the endoscope 353 or the surgical field camera 352 in addition to the functions illustrated in FIG. 1. The communication terminal 30 can display the received video, including a wide-view image, on displays 306 and transmit the received video to the information processing system 50 as video of the site at which the communication terminal 30 is located.

An operation panel 357 is an input interface that accepts various operations. In one example, a medical professional operates a device in the operating room via the operation panel 357. The endoscope 353, the surgical camera 351, and the surgical field camera 352 may communicate with the information processing system 50 directly without the intervention of the communication terminal 30. As described above, since a plurality of image capturing apparatuses 10 can be associated with the same virtual room, a user at a remote site can issue a request to capture wide-view images of various on-site scenes at the site A. For example, a user who desires to capture an image of the inside of the patient's body can transmit an image capturing request to an image capturing apparatus corresponding to the endoscope 353. A user who desires to capture an image of the entire operating room can transmit an image capturing request to an image capturing apparatus corresponding to the surgical camera 351.

The communication terminal 30 may have the function of an electronic medical record system. The communication terminal 30 may have the function of communicating with an electronic medical record system. The communication terminal 30 may display a wide-view image and information on an electronic medical record on the displays 306. The storage 90 may be an electronic medical record system. In this case, a wide-view image captured in response to an image capturing request (and point-of-view information associated with the wide-view image) is stored by the association processing unit 53 in association with the electronic medical record of the patient. Folders indicated by storage locations of the storage 90 can be classified by patient or surgery. The virtual room information storage unit 5002 stores information indicating a patient or the details of surgery in association with each other. As a result, information related to the patient or the surgery can be continuously displayed on a viewing screen of the communication terminal 30.

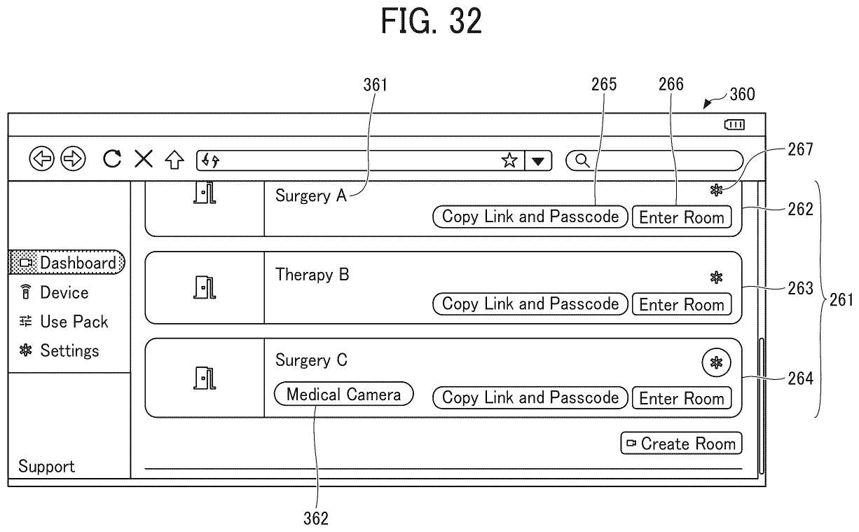

FIG. 32 is a diagram illustrating an example of a virtual room association screen 360 for associating an image capturing apparatus with a virtual room for telemedicine. In the description of FIG. 32, differences from FIG. 17 will be described.

In telemedicine, in one example, the virtual room association screen 360 displays a list of virtual rooms 361 associated with remote surgery or medical therapy. One of the virtual rooms 361 is associated with a medical camera 362 including a spherical camera. Examples of the medical camera 362 include an endoscope, a surgical field camera for use in capturing a surgical field image in an operating room, and a camera that captures a microscopic image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In the example configurations such as that illustrated in FIG. 13, the information processing system 50, the image capturing apparatus 10, and the communication terminal 30 are divided according to main functions thereof to facilitate understanding of the processes performed by the information processing system 50, the image capturing apparatus 10, and the communication terminal 30. No limitation on the present disclosure is intended by how the functions are divided by process or by the name of the functions. The processing of each of the information processing system 50, the image capturing apparatus 10, and the communication terminal 30 may be divided into more units of processing in accordance with the content of the processing. Further, the division may be made such that each unit of processing includes more processing operations.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in one or more embodiments of the present disclosure are merely examples of multiple computing environments that implement the embodiment disclosed herein. In some embodiments, the information processing system 50 includes multiple computing devices such as a server cluster. The multiple computing devices communicate with one another through any type of communication link including a network, shared memory, or the like and perform the processes disclosed herein.

Further, the information processing system 50 can be configured to share the processing steps disclosed herein, for example, the processing steps illustrated in FIGS. 21, 22, 25, 30, and so on in various combinations. For example, a process executed by a predetermined unit may be executed by multiple information processing apparatuses included in the information processing system 50. The components of the information processing system 50 may be integrated into one server apparatus or divided into multiple apparatuses.

In Aspect 1, a communication system includes a plurality of communication terminals and an information processing system. The information processing system distributes distribution image data including a plurality of images captured at a plurality of sites to the plurality of communication terminals. The communication system further includes a viewing-state recording unit and a display control unit. The viewing-state recording unit stores viewing-state information in a storage unit in association with the distribution image data. The viewing-state information indicates a viewing state received from each of the plurality of communication terminals in response to an operation by each of the plurality of communication terminals on a respective one of the plurality of images included in the distribution image data. The display control unit receives a reproduction request for reproducing the distribution image data from a communication terminal among the plurality of communication terminals after the distribution image data is distributed, and causes the communication terminal from which the reproduction request is received to display a viewing result that is based on the viewing-state information.

According to Aspect 2, the communication system of Aspect 1 further includes an image capturing apparatus. The image capturing apparatus captures a wide-view image having a wide viewing angle. The distribution image data includes wide-view image data indicating the wide-view image captured by the image capturing apparatus.

According to Aspect 3, in the communication system of Aspect 1 or Aspect 2, the viewing result includes reproduction image data in which the viewing states indicated by the viewing-state information are reflected, the viewing-state information includes information indicating a site at which an image focused on by each of the plurality of communication terminals is captured, and the reproduction image data includes information indicating a site of highest interest among the plurality of sites, the site of highest interest being focused on by a largest number of communication terminals among the plurality of communication terminals.

According to Aspect 4, in the communication system of any one of Aspects 1 to 3, the viewing-state information includes point-of-view information indicating, for each of the plurality of communication terminals, a point of view designated for the communication terminal in the wide-view image, and the reproduction image data includes a point of view of highest interest in the wide-view image, the point of view of highest interest being determined based on the point-of-view information indicating, for each of the plurality of communication terminals, a point of view designated for the communication terminal in the wide-view image.

According to Aspect 5, the communication system of any one of Aspects 1 to 4 further includes a site-of-interest specifying unit. The site-of-interest specifying unit specifies the site of highest interest focused on by the largest number of communication terminals, based on an aggregate result of the viewing-state information.

According to Aspect 6, the communication system of any one of Aspects 1 to 5 further includes a point-of-view-of-interest determination unit. The point-of-view-of-interest determination unit determines the point of view of highest interest in the wide-view image, using the point-of-view information indicating, for each of the plurality of communication terminals, a point of view designated for the communication terminal in the wide-view image.

In Aspect 7, an information processing system for distributing distribution image data including a plurality of images captured at a plurality of sites to a plurality of communication terminals, each located at a respective one of the plurality of sites, includes a viewing-state recording unit and a display control unit. The viewing-state recording unit stores viewing-state information in a storage unit in association with the distribution image data. The viewing-state information indicates a viewing state received from each of the plurality of communication terminals in response to an operation by each of the plurality of communication terminals on a respective one of the plurality of images included in the distribution image data. The display control unit receives a reproduction request for reproducing the distribution image data from a communication terminal among the plurality of communication terminals after the distribution image data is distributed, and causes the communication terminal from which the reproduction request is received to display a viewing result that is based on the viewing-state information.

In Aspect 8, an information processing method performed by an information processing system for distributing distribution image data including a plurality of images captured at a plurality of sites to a plurality of communication terminals, each located at a respective one of the plurality of sites, includes, by the information processing system, storing viewing-state information in a storage unit in association with the distribution image data, the viewing-state information indicating a viewing state received from each of the plurality of communication terminals in response to an operation by each of the plurality of communication terminals on a respective one of the plurality of images included in the distribution image data; receiving a reproduction request for reproducing the distribution image data from a communication terminal among the plurality of communication terminals after the distribution image data is distributed; and causing the communication terminal from which the reproduction request is received to display a viewing result that is based on the viewing-state information.

In Aspect 9, a program cause an information processing system for distributing distribution image data including a plurality of images captured at a plurality of sites to a plurality of communication terminals, each located at a respective one of the plurality of sites, to execute an information processing method including storing viewing-state information in a storage unit in association with the distribution image data, the viewing-state information indicating a viewing state received from each of the plurality of communication terminals in response to an operation by each of the plurality of communication terminals on a respective one of the plurality of images included in the distribution image data; receiving a reproduction request for reproducing the distribution image data from a communication terminal among the plurality of communication terminals after the distribution image data is distributed; and causing the communication terminal from which the reproduction request is received to display a viewing result that is based on the viewing-state information.

1. A system comprising circuitry configured to:
distribute distribution image data to a plurality of communication terminals each located at a respective one of a plurality of sites, the distribution image data including a plurality of images captured at the plurality of sites;
receive viewing-state information indicating a viewing state from each of the plurality of communication terminals in response to an operation by each of the plurality of communication terminals on a respective one of the plurality of images;
store the received viewing-state information in a memory in association with the distribution image data;
receive a reproduction request for reproducing the distribution image data from a communication terminal among the plurality of communication terminals after the distribution image data is distributed; and
cause the communication terminal from which the reproduction request is received to display a viewing result, the viewing result being based on the viewing-state information.

2. The system according to claim 1, wherein each of the plurality of images includes wide-view image data indicating a wide-view image having a wide viewing angle.

3. The system according to claim 2, wherein
the viewing result includes reproduction image data in which the viewing states indicated by the viewing-state information are reflected,
the viewing-state information includes information indicating a site at which an image focused on by each of the plurality of communication terminals is captured, and
the reproduction image data includes information indicating a site of highest interest among the plurality of sites, the site of highest interest being focused on by a largest number of communication terminals among the plurality of communication terminals.

4. The system according to claim 3, wherein
the viewing-state information includes point-of-view information indicating, for each of the plurality of communication terminals, a point of view designated for the communication terminal in the wide-view image, and
the reproduction image data includes a point of view of highest interest in the wide-view image, the point of view of highest interest being determined based on the point-of-view information indicating, for each of the plurality of communication terminals, a point of view designated for the communication terminal in the wide-view image.

5. The system according to claim 3, wherein
the circuitry is configured to specify the site of highest interest focused on by the largest number of communication terminals, based on an aggregate result of the viewing-state information.

6. The system according to claim 4, wherein
the circuitry is configured to determine the point of view of highest interest in the wide-view image, using the point-of-view information indicating, for each of the plurality of communication terminals, a point of view designated for the communication terminal in the wide-view image.

7. The system according to claim 1, further comprising:
the plurality of communication terminals; and
an information processing system including the circuitry.

8. The system according to claim 1, further comprising
an image capturing apparatus to capture a wide-view image having a wide viewing angle, wherein
the distribution image data includes wide-view image data indicating the wide-view image captured by the image capturing apparatus.

9. An information processing method comprising:
distributing distribution image data to a plurality of communication terminals each located at a respective one of a plurality of sites, the distribution image data including a plurality of images captured at the plurality of sites;
receiving viewing-state information indicating a viewing state from each of the plurality of communication terminals in response to an operation by each of the plurality of communication terminals on a respective one of the plurality of images;
storing the received viewing-state information in a memory in association with the distribution image data;
receiving a reproduction request for reproducing the distribution image data from a communication terminal among the plurality of communication terminals after the distribution image data is distributed; and
causing the communication terminal from which the reproduction request is received to display a viewing result, the viewing result being based on the viewing-state information.

10. A non-transitory recording medium storing a plurality of instructions which, when executed by one or more processors, causes the one or more processors to perform an information processing method comprising:
distributing distribution image data to a plurality of communication terminals each located at a respective one of a plurality of sites, the distribution image data including a plurality of images captured at the plurality of sites;
receiving viewing-state information indicating a viewing state from each of the plurality of communication terminals in response to an operation by each of the plurality of communication terminals on a respective one of the plurality of images;
storing the received viewing-state information in a memory in association with the distribution image data;
receiving a reproduction request for reproducing the distribution image data from a communication terminal among the plurality of communication terminals after the distribution image data is distributed; and
causing the communication terminal from which the reproduction request is received to display a viewing result, the viewing result being based on the viewing-state information.
